(19) United States
(12) Patent Application Publication
(10) Pub. No.: US 2025/0215138 A1
(43) Pub. Date: Jul. 3, 2025

(54) METHODS FOR CONVERTING SOLID POLYURETHANE ARTICLES

(71) Applicant: BASF SE, Ludwigshafen am Rhein (DE)

(72) Inventors: Xue LIU, Beachwood, OH (US); Willie G. WESLEY, Wyandotte, MI (US); Patrick Neal HAMILTON, Freeport, TX (US)

(21) Appl. No.: 18/852,546

(22) PCT Filed: Mar. 31, 2023
(86) PCT No.: PCT/US2023/017055

§ 371 Date: Sep. 30, 2024

Related U.S. Application Data
(60) Provisional application No. 63/326,618, filed on Apr. 1, 2022.

(51) Int. Cl. C08G 18/10; C08G 18/08; C08G 18/76; C08J 9/36; C08J 11/28

(52) U.S. Cl. CPC C08G 18/10; C08G 18/0895; C08G 18/7621; C08J 9/36; C08J 11/28; C08J 2375/04

(57) ABSTRACT

Provided herein are methods for the continuous production of liquid polyurethane pre-polymer from pre-formed solid polyurethane articles with toluene diisocyanate composition under defined conditions. The methods include methods of producing polyurethane pre-polymers. methods of recycling pre-formed polyurethane articles. and methods of converting solid polyurethane articles into a liquid polyurethane material.

### BACKGROUND OF THE INVENTION

### Field of the Invention

The present invention relates generally to pre-formed solid polyurethane articles, and more specifically to methods of converting pre-formed solid polyurethane articles into liquid polyurethane pre-polymer.

Background Information

Polyurethanes are a class of materials which offer unique physical properties and are suitable for use in a range of applications. Polyurethanes are provided in non-cellular, cellular, or microcellular forms and can be further categorized as rigid, semirigid, or flexible polyurethanes. Depending upon the formulations used to form the polyurethanes, they can also be categorized as thermoplastic or thermosetting polymers, as well as elastomeric or non-elastomeric polymers.

Two types of polyurethanes that find usage in a wide variety of polyurethane articles include thermoplastic polyurethanes (TPUs) and cellular foams (including, for example, microcellular foam (MCU)). TPU is a block copolymer including hard and soft segments (or domains) formed by the reaction of diisocyanates with short-chain diols and long-chain diols. TPUs are typically processed in an extruder or an injection molding device to produce polyurethane articles used in various applications, including but not limited to automotive, footwear, and medical applications. Cellular foams are typically processed by mixing liquid components in a mold under low pressure in the presence of a blowing agent to produce foam polyurethane articles that are also used in automotive and footwear applications. MCU foams are also formed through a two-step process, as is known in the art, in which an isocyanate prepolymer is formed through an exothermic reaction of a hydroxyl-functional polymer containing two or more hydroxyl groups and a diisocyanate. A portion of the isocyanate prepolymer reacts with water to create a carbon dioxide off-gas, and the release of the off-gas creates a cellular structure. In certain cases, an auxiliary blowing agent is included. The cellular structure is cured, therein forming the MCU foam.

As the prevalence of TPU and cellular foams such as MCU foam are used in forming polyurethane articles increases, the potential for an adverse environmental burden also increases. Typically, after use, polyurethane articles are disposed of in landfills and may create an adverse environmental burden. The polyurethane articles may be in the form of a trimming, a slab, or a formed part (wherein the formed part is actually used for its intended purpose or disposed of prior to use for a variety of reasons) and may be disposed of after off-specification production or after an end use. Due to the potentially adverse environmental burden resulting from the disposal of the polyurethane articles, it would be advantageous to recycle these polyurethane articles.

Various methods of recycling polyurethane articles, including recycling polyurethane articles from the aforementioned TPU and cellular foams, are known in the prior art. These recycling methods generally include mechanical recycling, in which the polyurethane articles are reused in its polymer form, and chemical recycling, in which the polyurethane articles are broken down into various chemical constituents. General examples of mechanical recycling of polyurethane articles include, but are not limited to, flexible foam rebond, compression, regrind, powdering (i.e., pulverizing or comminuting), and any combination thereof. One specific example of a mechanical recycling method is disclosed in the U.S. Pat. No. 5,908,894 to Genz et al. More specifically, Genz et al. discloses a process for preparing a TPU compound with reuse of a pulverized MCU. More specifically, the process prepares the TPU compound by reacting an isocyanate, a compound reactive towards an isocyanate, and optionally a chain extender, a catalyst, an auxiliary, and an additive such as a plasticizer with the pulverized microcellular foam. General examples of chemical recycling of polyurethane articles include, but are not limited to, hydrogenation, pyrolysis, hydrolysis, glycolysis, alcoholysis, acidolysis, cleavage (thermal cleavage or alkaline cleavage), aminolysis, solvolysis, and any combination thereof. Many of these chemically recycling processes are time consuming and cost prohibitive. In addition, certain chemical recycling processes utilize, or result in the formation of other chemical compounds, such as aromatic amines, that are mixed with the desired product that require separation and disposal that may lead to enhanced environmental concerns as well as increase costs.

Pre-formed polyurethane articles can also be recycled in batch. Batch recycling of polyurethane articles with isocyanates utilizes large volumes of toluene diisocyanate (TDI) to allow the processing of voluminous but low-density (i.e., light weighted) pre-formed polyurethane articles, making it difficult to scale-up. Operating temperature and foam addition rate are limiting factors for batch recycling of polyurethane foam with toluene diisocyanate.

The present invention provides an improved process for recycling pre-formed polyurethane articles using TDI by creating a continuous process allowing the pre-formed polyurethane articles and TDI composition to mix in an extruder setup with adequate residence time to liquify the pre-formed polyurethane articles and produce soluble TDI capped polyurethane prepolymers. By designing a continuous process, the TDI in the process has been reduced allowing for better control without limiting throughput compared to a batch process. Issues related to handling large volumes of low-density pre-formed polyurethane articles which limit batch process times have been also addressed by using the continuous process and a chemical means to speed up and stabilize the resulting polyurethane pre-polymers has been implemented.

### SUMMARY OF THE INVENTION

The present invention is based on the seminal discovery that by pre-heating a TDI composition in an external vessel and contacting a pre-formed, solid polyurethane article and the pre-heated TDI composition concurrently a continuous process can produce an isocyanate functional liquid prepolymer.

In one embodiment, the present invention provides a method of producing a polyurethane pre-polymer including: a) processing and/or densifying a pre-formed polyurethane article, b) pre-heating a toluene diisocyanate composition at a temperature ranging from about 130 to 165° C., and c) contacting the processed and/or densified pre-formed polyurethane article with the toluene diisocyanate composition, thereby producing a polyurethane pre-polymer.

In one aspect, the toluene diisocyanate composition includes between about 50% and 75% of toluene-2,4-diisocyanate and between about 10% and 15% of toluene-2,6-diisocyanate. In another aspect, the toluene diisocyanate composition includes between about 50% and 75% of toluene-2,4-diisocyanate and between about 15% and 20% of toluene-2,6-diisocyanate. In an additional aspect, the toluene diisocyanate composition includes between about 60% and 80% of toluene-2,4-diisocyanate and between about 10% and 20% of toluene-2,6-diisocyanate. In one aspect, the pre-formed polyurethane article is a polyurethane foam. In some aspects, the processing and/or densifying step occurs prior to, after, or concurrently with the pre-heating step. In other aspects, increasing the pre-heating temperature decreases processing time. In one aspect, the polyurethane foam is selected from the group consisting of microcellular foam, semi-rigid foam, molded foam, and any combination thereof. In some aspects, the foam includes polyols having a molecular weight ranging from about 1000 to 3600 Da. In other aspects, processing and/or densifying the foam includes grinding the foam to obtain shredded foam. In another aspect, the shredded foam fragments have a size ranging from about 500 μm to 5 mm. In some aspects, the shredded foam fragments have a size of about 1 mm. In various aspects, processing and/or densifying comprises using a grinder, a processor, a shredder, a granulator, a crusher, a compactor or a miller. In one aspect, the production is a continuous process. In another aspect, the pre-heating temperature ranges from about 160 to 165° C. In one aspect, contacting includes contacting about 1-30% w/w foam with the polyurethane composition. In one aspect, the method further includes stirring the pre-formed polyurethane article and the heated polyurethane composition. In another aspect, the temperature of the toluene diisocyanate composition is maintained at a temperature ranging from about 130 to 165° C. during the contacting step. In an additional aspect, a catalyst is added after step (b).

In another embodiment, the invention provides a method of recycling a pre-formed polyurethane article including: (a) processing and/or densifying the pre-formed polyurethane article, (b) heating a toluene diisocyanate composition at a temperature ranging from about 130 to 165° C., (c) contacting the pre-formed polyurethane article with the heated toluene diisocyanate composition of (b), and (d) producing a soluble isocyanate terminated liquid pre-polymer, thereby recycling the pre-formed polyurethane article.

In one aspect, the pre-heating temperature ranges from about 160 to 165° C. In another aspect, the pre-formed polyurethane article is a pre-formed polyurethane foam. In another aspect, the method further includes adding a catalyst after step (b). In some aspects, the catalyst includes dibutyltin dilaurate (DABCO T12). In other aspects, the method further includes adding diethylene glycol bis chloroformate (DIBIS). In various aspects, DIBIS mitigates DABCO T12-induced overtime solidification of the pre-polymer. In some aspects, DIBIS prevents DABCO T12-induced reduction of the pre-polymer stability. In some aspects, the toluene diisocyanate composition is selected from the group consisting of: a polyurethane composition comprising between about 50% and 75% of toluene-2,4-diisocyanate and between about 10% and 15% of toluene-2,6-diisocyanate; a polyurethane composition comprising between about 50% and 75% of toluene-2,4-diisocyanate and between about 15% and 20% of toluene-2,6-diisocyanate; and a polyurethane composition comprising between about 60% and 80% of toluene-2,4-diisocyanate and between about 10% and 20% of toluene-2,6-diisocyanate.

In an additional embodiment, the invention provides a method of converting a pre-formed polyurethane article into a liquid polyurethane material including: (a) processing and/or densifying the pre-formed polyurethane article, (b) heating a toluene diisocyanate composition at a temperature ranging from about 130 to165° C., (c) contacting the pre-formed polyurethane article with the heated toluene diisocyanate composition of (b), and (d) producing a soluble isocyanate terminated liquid pre-polymer, thereby converting the pre-formed polyurethane article into a liquid polyurethane material.

In one aspect, the pre-heating temperature ranges from about 160 to 165° C. In another aspect, converting the pre-formed polyurethane article includes producing a polyurethane pre-polymer. In some aspects, the pre-polymer is used for the production of industrial chemicals and/or industrial polymers.

### BRIEF DESCRIPTION OF THE DRAWINGS

FIG. 1 illustrates the general polyurethane foam conversion process.

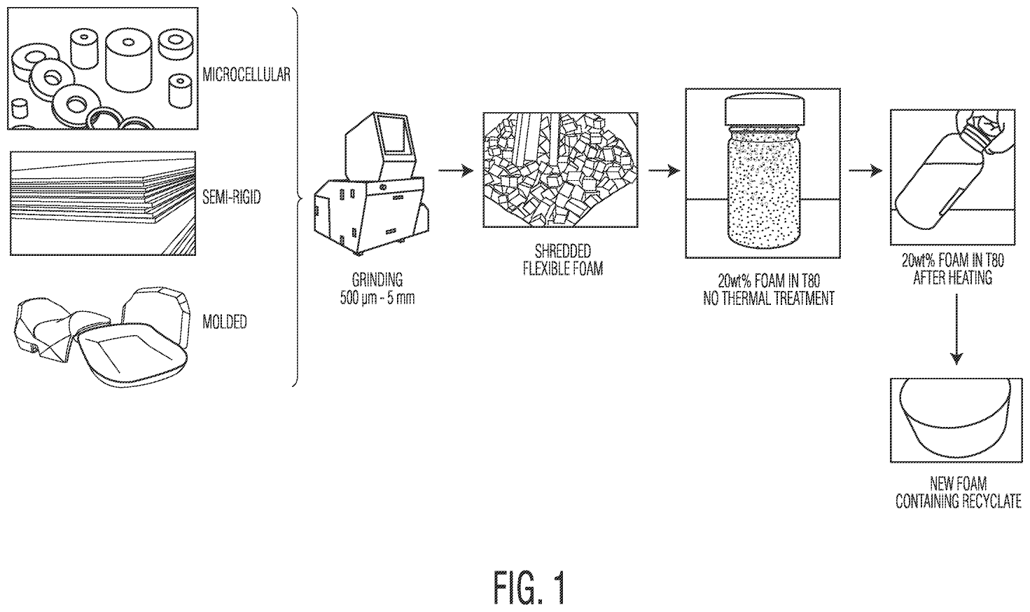

### DETAILED DESCRIPTION OF THE INVENTION

The present invention is based on the seminal discovery that by pre-heating a TDI composition in an external vessel and contacting a pre-formed, solid polyurethane article and the pre-heated TDI concurrently in a continuous process an isocyanate functional liquid prepolymer can be produced.

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

All publications, patents, and patent applications mentioned in this specification are herein incorporated by reference to the same extent as if each individual publication, patent, or patent application was specifically and individually indicated to be incorporated by reference.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, it will be understood that modifications and variations are encompassed within the spirit and scope of the instant disclosure. The preferred methods and materials are now described.

Batch recycling of pre-formed, solid polyurethane articles with isocyanates utilizes large volumes of the polyurethane articles and toluene diisocyanate (TDI) making scale-up difficult. Operating temperature and polyurethane article addition rate are limiting factors for batch recycling of polyurethane article with toluene diisocyanate. Recycling of more than 1 wt % of the polyurethane articles in isocyanates is difficult because the low density and volume of the polyurethane articles prevents complete addition of the polyurethane articles. Beyond this amount, the liquid is absorbed in the polyurethane articles and the process is greatly limited due to poor heat transfer. Therefore, the polyurethane articles must be added slowly to facilitate good liquid contact with the polyurethane articles with external heating. The reaction time at 130° C. is long due to the slow dissolution of polyurethane articles into the liquid media greatly limiting the amount of polyurethane articles that can be added per unit time. Running the reaction at 165° C. allows for almost instantaneous dissolution/reaction of the polyurethane articles to produce a soluble isocyanate terminated pre-polymer. However, thermal events for this process can occur at temperatures as low as 180° C. with 200°° C. bringing the largest build in thermal energy and pressure generation. This is problematic for scale-up, because the majority of the potential chemical energy for this thermal event is contained in the TDI.

In one embodiment the present invention provides, a method of producing a polyurethane pre-polymer by processing and/or densifying a pre-formed polyurethane article, pre-heating a toluene diisocyanate composition at a temperature ranging from about 130 to 165° C., and contacting the processed and/or densified pre-formed polyurethane articles with a toluene diisocyanate composition, thereby producing a polyurethane pre-polymer. The pre-formed polyurethane articles can be recycled polyurethane articles.

The terms “pre-formed polyurethane article” and “solid polyurethane article” are used interchangeably and refer to polyurethane objects that have been formed (i.e., are pre-formed) as the reaction product of an isocyanate component (alternatively referred to herein as an isocyanate) and an isocyanate-reactive component.

The term “recycled”, as used hereinafter in the phrase “recycled polyurethane articles”, refers in general to the use of previously formed (“pre-formed”) polyurethane objects or materials. In other words, any previously formed polyurethane object or material may be used, including those that were used for the prior intended purpose (such as, for example, footwear, automotive headliners or front panels, and the like) or were otherwise not used for any intended purpose (i.e., virgin material, such as scrap or unused commercial products and the like). In other words, the only requirement is for the polyurethane article to be considered a “recycled polyurethane article” as used herein is that it was a pre-formed polyurethane object or material and is now available for use. The recycled polyurethane articles may be in the form of conventional, slab, or molded flexible foam; rigid, semirigid open and closed foam; microcellular polyurethane (MCU) foam, a thermoplastic polyurethane (TPU) and any combination thereof.

Isocyanate-functional polymer component can be formed by reacting recycled polyurethane article in liquid form and an isocyanate component having a known isocyanate-functional group content (NCO content) to form the isocyanate-functional polymer component having an NCO content that is less than the isocyanate component. Isocyanate-functional polymer component formed as above can be subsequently used to form a new polyurethane article, or a new polyurethane foam article, in accordance with other embodiments of the subject disclosure. The isocyanate-functional polymer component of the subject disclosure, and the new polyurethane article, as well as the associated methods for producing polyurethane pre-polymer component and related new polyurethane article, are described in further detail below.

As noted above, recycled polyurethane articles are used to form an isocyanate-functional polymer component. The isocyanate-functional polymer component can be formed by reacting the recycled polyurethane article and an isocyanate component having a known isocyanate-functional group content (NCO content) to form the isocyanate-functional polymer component having an NCO content that is less than the isocyanate component. “NCO content”, as used herein, refers to the isocyanate-functional group content of a particular isocyanate component as measured in accordance with ISO 14896/3 or the ASTM equivalent ASTM D2572, hereinafter referred to collectively as ASTM D2572.

Recycled polyurethane articles are polyurethane objects or materials that have previously been formed (i.e., are pre-formed) as the reaction product of an isocyanate component (alternatively referred to herein as an isocyanate) and an isocyanate-reactive component. Preferably, the recycled polyurethane articles of the subject disclosure are in the form of comminuted polyurethane articles. Comminuted polyurethane articles refer to polyurethane articles that are in powder form, or otherwise are in the form of minute particles or fragments.

Typically, the system used to form such recycled polyurethane articles is provided in two or more discrete components, such as the isocyanate component and the isocyanate-reactive (or resin) component, i.e., as a two-component (or 2K) system, which is described further below. It is to be appreciated that reference to the isocyanate component and isocyanate-reactive component, as used herein, is merely for purposes of establishing a point of reference for placement of the individual components of the system, and for establishing a part by weight basis. As such, it should not be construed as limiting the recycled polyurethane article to only a 2K system. For example, the individual components of the system for pre-forming the recycled polyurethane article can all be kept distinct from each other.

As described above, recycled polyurethane articles have been pre-formed as the reaction product of the isocyanate-reactive component and the isocyanate component. It is to be appreciated that one or more isocyanates can be reacted with one or more isocyanate-reactive components to form the recycled polyurethane article. It is also to be appreciated that the isocyanate component is not limited to any particular genus of isocyanate, e.g., the isocyanate component can include monomeric isocyanate, polymeric isocyanate, and mixtures thereof. In addition, the isocyanate component can include prepolymers, e.g., hydroxyl-functional polymers reacted with excess isocyanate.

In certain aspects, the isocyanate-reactive component comprises a hydroxyl functional polymer component (sometimes alternatively referred to as a polyol), which is reactive with the isocyanate-functional groups of the isocyanate component. It is to be appreciated that the isocyanate-reactive component can include one or more hydroxyl-functional polymers. Typically, the isocyanate-reactive component includes a combination of hydroxyl-functional polymers. The hydroxyl-functional polymers include one or more OH functional groups, typically at least two OH functional groups. The hydroxyl-functional polymer typically includes a conventional hydroxyl-functional polymer, such as polyether hydroxyl-functional polyether polymer and/or a hydroxyl-functional polyester polymer. Other suitable hydroxyl-functional polymers include, but are not limited to, bio polyols, such as soybean oil, castor-oil, soy-protein, rapeseed oil, etc., and combinations thereof.

In some aspects, the isocyanate-reactive component for forming the recycled polyurethane article comprises a hydroxyl-functional polyether polymer. Suitable hydroxyl-functional polyether polymers, for purposes of the subject disclosure include, but are not limited to, products obtained by the polymerization of a cyclic oxide, for example ethylene oxide (EO), propylene oxide (PO), butylene oxide (BO), or tetrahydrofuran in the presence of polyfunctional initiators. Suitable initiator compounds contain a plurality of active hydrogen atoms, and include water, butanediol, ethylene glycol, propylene glycol (PG), diethylene glycol, triethylene glycol, dipropylene glycol, ethanolamine, diethanolamine, triethanolamine, toluene diamine, diethyl toluene diamine, phenyl diamine, diphenylmethane diamine, ethylene diamine, cyclohexane diamine, cyclohexane dimethanol, resorcinol, bisphenol A, glycerol, trimethylolpropane, 1,2,6-hexanetriol, pentaerythritol, and combinations thereof. Other suitable hydroxyl-functional polyether polymers include polyether diols and triols, such as polyoxypropylene diols and triols and poly (oxyethyleneoxypropylene) diols and triols obtained by the simultaneous or sequential addition of ethylene and propylene oxides to di-or trifunctional initiators. Copolymers having oxyethylene contents of from about 5 to about 90% by weight, based on the weight of the hydroxyl-functional polyether polymer component, of which the hydroxyl functional polyether polymers may be block copolymers, random/block copolymers or random copolymers, can also be used. Yet other suitable hydroxyl-functional polyether polymers include polytetramethylene glycols obtained by the polymerization of tetrahydrofuran. In one embodiment, the hydroxyl-functional polyether polymer is a polyether triol. In this embodiment, the polyether triol has a hydroxyl number of from 20 to 90, more typically from 40 to 70, and most typically 50 to 60, mg KOH/g. Further, the polyether triol of this embodiment typically has a weight average molecular weight of from 1,000 to 10,000,more typically from 2,000 to 6,000, and most typically from 2,500 to 3,500, g/mol. In this embodiment, the hydroxyl-functional polyether polymer is typically present in the isocyanate-reactive component in an amount of greater than 10, more typically greater than 50, still more typically from 75 to 100, and most typically from 85 to 100, parts by weight, based on 100 parts by weight of total hydroxyl functional polymer present in the isocyanate-reactive component.

In other aspects, the isocyanate-reactive component comprises a graft polyol. The graft polyol is dispersed polymer solids chemically grafted to a carrier polyol. More specifically, the graft polyol comprises the carrier polyol and particles of copolymerized styrene and acrylonitrile, wherein the particles of co-polymerized styrene and acrylonitrile are dispersed in the carrier polyol, as set forth in more detail below. The graft polyol typically has a nominal functionality of from 2 to 4, more typically from 2.5 to 3.5 and typically has a hydroxyl number of from 10 to 100, more typically from 15 to 50, and most typically 20 to 35, mg KOH/g. Typically, the carrier polyol of the graft polyol is a hydroxyl-functional polyether polymer. The carrier polyol may be any known hydroxyl-functional polyether polymer in the art and preferably serves as a continuous phase for the dispersed copolymerized styrene and acrylonitrile particles. That is, the co-polymerized styrene and acrylonitrile particles are dispersed in the carrier polyol to form a dispersion, i.e., to form the graft polyol. The particles of co-polymerized styrene and acrylonitrile are typically dispersed in the carrier polyol in an amount of from 10 to 70, more typically from 15 to 60, and most typically from 20 to 55, parts by weight, based on 100 parts by weight of the graft polyol. If present, the graft polyol is typically present in the isocyanate-reactive component in an amount of from 5 to 100, more typically from 10 to 90, and most typically from 15 to 80, parts by weight, based on 100 parts by weight of total polyol present in the isocyanate-reactive component.

In yet other aspects, the isocyanate-reactive component comprises a graft polyol and a hydroxyl-functional polyether polymer having a functionality of greater than 2 and a hydroxyl number of from 15 to 100, more typically from 20 to 50, and most typically 25 to 35, mg KOH/g. One non-limiting example of the hydroxyl functional polyether polymer of this embodiment is a primary hydroxyl terminated polyether triol. If present, the polyether polyol is typically present in the isocyanate-reactive component in an amount of from 5 to 100, more typically from 10 to 75, and most typically from 15 to 45, parts by weight based on 100 parts by weight of total polyol present in the isocyanate-reactive component. If the graft polyol and the hydroxyl-functional polyether polymer are both present in the isocyanate-reactive component, they are typically present in a ratio of from 1:2 to 6:1, more typically from 1:1 to 5:1, and most typically from 2:1 to 4:1.

The isocyanate-reactive component used for pre-forming the recycled polyurethane article typically comprises one or more cross-linking agents. When utilized in the isocyanate-reactive component, the cross-linking agent generally allows phase separation between copolymer segments of the formed recycled polyurethane article. That is, the recycled polyurethane article typically comprises both rigid urea co-polymer segments and soft polyol copolymer segments. The cross-linking agent typically chemically and physically links the rigid urea copolymer segments to the soft polyol copolymer segments. Therefore, the cross-linking agent is typically present in the isocyanate-reactive component to modify the hardness, increase stability, and reduce shrinkage of the pre-formed recycled polyurethane article. One non-limiting example of a suitable cross-linking agent is diethanolamine.

The isocyanate-reactive component used for pre-forming the recycled polyurethane article also typically comprises one or more catalysts. The catalyst is typically present in the isocyanate-reactive component to catalyze the reaction between the isocyanate-functional groups of the isocyanate and the hydroxyl-functional groups of the isocyanate-reactive component. It is to be appreciated that the catalyst is typically not consumed in the exothermic reaction between the isocyanate and the hydroxyl-functional polymer component used to pre-form the recycled polyurethane article. More specifically, the catalyst typically participates in, but is not consumed in, the exothermic reaction. The catalyst may include any suitable catalyst or mixtures of catalysts known in the art. Examples of suitable catalysts include, but are not limited to, gelation catalysts, e.g., amine catalysts in dipropylene glycol; blowing catalysts, e.g., bis (dimethylaminoethyl) ether in dipropylene glycol; and metal catalysts, e.g., tin, bismuth, lead, etc. The isocyanate-reactive component used to pre-form the recycled polyurethane article, particularly pre-formed recycled polyurethane foam articles, also typically comprises one or more surfactants. The surfactant typically supports homogenization of a blowing agent and the hydroxyl-functional polymer component and regulates a cell structure of the pre-formed recycled polyurethane foam article. The surfactant may include any suitable surfactant or mixtures of surfactants known in the art. Nonlimiting examples of suitable surfactants include various silicone surfactants, salts of sulfonic acids, e.g., alkali metal and/or ammonium salts of oleic acid, stearic acid, dodecylbenzeneor dinaphthylmethanedisulfonic acid, and ricinoleic acid, foam stabilizers such as siloxaneoxyalkylene copolymers and other organopolysiloxanes, oxyethylated alkyl-phenols, oxyethylated fatty alcohols, paraffin oils, castor oil, castor oil esters, and ricinoleic acid esters, and cell regulators, such as paraffins, fatty alcohols, and dimethylpolysiloxanes. One specific, non-limiting example of a surfactant is a silicone glycol copolymer.

The isocyanate-reactive component used to pre-form the recycled polyurethane article may optionally include one or more additives. Suitable additives for purposes of the instant disclosure include, but are not limited to, chain-extenders, chain-terminators, processing additives, adhesion promoters, antioxidants, defoamers, anti-foaming agents, water scavengers, molecular sieves, fumed silicas, ultraviolet light stabilizers, fillers, thixotropic agents, silicones, colorants, inert diluents, and combinations thereof. If included, the additive can be included in the isocyanate-reactive component in various amounts.

When the pre-formed recycled polyurethane article is in the form of a foam (i.e., is a pre-formed recycled polyurethane foam article), the isocyanate and the isocyanate-reactive component are reacted in the presence of a blowing agent to form the preformed recycled polyurethane foam article. The blowing agent may be a physical blowing agent, a chemical blowing agent, or a combination of a physical blowing agent and chemical blowing agent.

The pre-formed recycled polyurethane foam article used in the subject application can be a “flexible polyurethane foam” or a “rigid polyurethane foam.” As used herein, the terminology “flexible polyurethane foam” denotes a particular class of polyurethane foam and stands in contrast to “rigid polyurethane foam.

The pre-formed recycled polyurethane foam article used in the subject application can be in the form of a “semi-rigid flexible polyurethane foam” (SRU), which includes attributes of both a “flexible polyurethane foam” and “rigid polyurethane foam” as described above.

In certain non-limiting aspects, the pre-formed recycled polyurethane foamed article is a microcellular polyurethane (MCU) foam. It is to be appreciated that the MCU foam may also include additional components other than the MCU.

The comminuted MCU foam may be obtained from a supplier. In another embodiment, the MCU foam may be provided in a non-powder form (i.e., a non-comminuted form) and pulverized to produce the comminuted MCU foam. In this latter case, the MCU foam may be obtained from pre-formed MCU foam object or material may be obtained from virgin material.

The pre-formed MCU foam as described above is distinguished from the virgin material in that the pre-formed MCU foam is initially formed for another use. In certain aspects, the recycled MCU foam originates as a slab, a trimming, or a formed article or is procured from a waste stream of a manufacturing process. Further, the recycled MCU foam may include a combination of different MCU foams, as described in further detail below, since the recycled MCU foam may be procured from multiple sources. In contrast, the virgin material is specifically created to produce an MCU foam and is procured from a product stream before being optionally pulverized to form the comminuted recycled MCU foam. Since the virgin material is prepared solely for use to form the isocyanate prepolymers and polyurethane elastomers of the subject disclosure (described below), the virgin material typically comprises only one type of MCU foam.

MCU foams are formed through a two-step process, as known in the art. First, an isocyanate prepolymer is formed through an exothermic reaction of a hydroxyl functional polymer containing two or more hydroxyl groups and a diisocyanate. Next, the isocyanate prepolymer reacts with water to create a carbon dioxide off-gas. A release of the carbon dioxide off-gas creates a cellular structure. The cellular structure is then cured, and thereby completes the formation of the MCU foam.

The MCU foam may include methyldiphenyl diisocyanate-based foam, naphthalene diisocyanate-based foam, tolidine diisocyanate-based foam, and combinations thereof. For example, as alluded to above, when the MCU foam is virgin material or from a single source, the MCU foam is typically solely methyldiphenyl diisocyanate based foam or naphthalene diisocyanate-based foam or tolidine diisocyanate-based foam. Alternatively, in another embodiment, the MCU foam may be a combination of methyldiphenyl diisocyanate-based foam, naphthalene diisocyanate-based foam, and tolidine diisocyanate-based foam, especially when the MCU foam is the recycled MCU foam. For example, when the MCU foam is recycled from a combination of slabs, trimmings, and formed articles, or is provided from multiple sources, the MCU foam is typically a combination of methyldiphenyl diisocyanate-based foam, naphthalene diisocyanate-based foam, and tolidine diisocyanate-based foam.

After pulverization, the particle size of the comminuted polyurethane article based on the MCU foam is preferably from 0.5 to 10 mm. Alternatively, as set forth above, the comminuted polyurethane article may be provided as a pre-made product, in which case the above steps are unnecessary. The resulting comminuted polyurethane article based on the MCU foam (i.e., the comminuted MCU foam) typically has a melt temperature of at least 100-350° C. (degrees Celsius), more typically at least 250° C.

After the comminuted polyurethane article based on the MCU foam is provided and prior to use in the subject disclosure, substantially all of the moisture may be eliminated from the comminuted polyurethane article. More specifically, the moisture is typically eliminated from the comminuted polyurethane article based on MCU foam until the water content is less than or equal to 0.03%. Typically, moisture is eliminated from the comminuted polyurethane article based on MCU foam by drying in an oven for at least 8 hours, but moisture may also be removed with an open heat source. After the moisture is substantially eliminated, the comminuted polyurethane article based on MCU foam may be stored under vacuum. Alternatively, a desiccant may be added, or a combination of storage under vacuum and the addition of a desiccant may be employed. After substantially all of the moisture is removed, the comminuted polyurethane article based on the MCU foam is suitable for use in forming the isocyanate prepolymer.

Exemplary commercially MCU foams that can be used to as the polyurethane article, or as the comminuted polyurethane article, of the subject disclosure include Cellasto® Series MCU foam products commercially available from BASF Corporation of Florham Park, New Jersey. Alternatively, MCU foams can be obtained from commercial products incorporating MCU foams, such as footwear, automotive headliners, automotive front panels, and the like.

In certain alternative aspects, the recycled polyurethane article, and typically a comminuted recycled polyurethane article, is a thermoplastic polyurethane (TPU).

The TPU of the subject disclosure are based on the reaction product of a polyol component and an isocyanate-functional component, such as a diisocyanate. Exemplary TPUs may be selected from the group of polyester-based TPUs, polyether-based TPUs, polybutadiene diol-based TPU, dimer-diol based TPU, polyTHF-based TPU, and combinations thereof. Typically, when both a polyester-based TPU and a polyether-based TPU are present, the polyester-based TPU and the polyether-based TPU are present in a ratio of from 1:9 to 9:1, more preferably in a ratio of from 1:7 to 7:1, and most preferably in a ratio of from 1:5 to 5:1.

The polyester-based TPU is formed as the reaction product of a polyester polyol and a diisocyanate. Polyester polyols suitable for producing the polyester-based TPU may comprise the reaction product of a dicarboxylic acid and a glycol having at least one primary hydroxyl group. Dicarboxylic acids that are suitable for producing the polyester polyols may be selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols that are suitable for producing the polyester polyols may be selected from the group of, but are not limited to, ethylene glycol, butylene glycol, hexanediol, bis (hydroxymethylcyclohexane), 1,4-butanediol, diethylene glycol, 2,2-dimethyl propylene glycol, 1,3-propylene glycol, and combinations thereof. Diisocyanates that are suitable for producing the polyester-based TPU may be selected from the group of, but are not limited to, 4,4′-diphenylmethane diisocyanate, 2,4′-diphenylmethane diisocyanate, ethylene diisocyanate, ethylidene diisocyanate, propylene diisocyanate, butylene diisocyanate, cyclopentylene-1,3-diisocyanate, cyclohexylene-1,4-diisocyanate, cyclohexylene-1,2-diisocyanate, 2,4-toluylene diisocyanate, 2,6-toluylene diisocyanate, 2,2-diphenylpropane-4,4′-diisocyanate, phenylene diisocyanate, m-phenylene diisocyanate, xylylene diisocyanate, 1,4naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, tetramethylene diisocyanate, pentamethylene diisocyanate, hexamethylene diisocyanate, 1-chlorobenzene-2,4-diisocyanate, furfurylidene diisocyanate, and combinations thereof. In addition, the polyester-based TPU may also include the reaction product of a suitable chain extender. Suitable chain extenders may be selected from the group of, but are not limited to, diols including ethylene glycol, propylene glycol, butylene glycol, 1,4-butanediol, butenediol, butynediol, xylylene glycols, amylene glycols, 1,4phenylene-bis-hydroxy ethyl ether, 1,3-phenylene-bis-hydroxy ethyl ether, bis (hydroxy-methyl-cyclohexane), hexanediol, and thiodiglycol; diamines including ethylene diamine, propylene diamine, butylene diamine, hexamethylene diamine, cyclohexalene diamine, phenylene diamine, tolylene diamine, xylylene diamine, 3,3′dichlorobenzidine, and 3,3′-dinitrobenzidine; alkanol amines such as ethanol amine, aminopropyl alcohol, 2,2-dimethyl propanol amine, 3-aminocyclohexyl alcohol, and paminobenzyl alcohol; and combinations thereof. Specific examples of polyesterbased TPUs that are suitable for the purposes of the subject disclosure include Elastollan® 600 Series polyester-based TPU resins commercially available from BASF Corporation of Florham Park, New Jersey. The polyether-based TPU includes the reaction product of a polyether polyol and a diisocyanate. Suitable diisocyanates include any of those mentioned above as suitable for producing the polyester-based TPU resin. Glycols suitable for producing the polyether-based TPU may be selected from the group of, but are not limited to, polytetramethylene glycol, polyethylene glycol, polypropylene glycol, and combinations thereof. Like the polyester-based TPU resin, the polyether-based TPU may also include the reaction product of a suitable chain extender, and the chain extenders set forth above are also suitable for producing the polyether-based TPU resin. Specific examples of polyether-based TPU resins that are suitable include Elastollan® 1100 Series polyether-based TPU resins available from BASF Corporation of Florham Park, New Jersey. Similar to the MCU foam above, the TPU of the subject disclosure, after production, may be pulverized to form a comminuted TPU. Alternatively, the TPU may be provided from a supplier as a comminuted TPU for utilization in the subject disclosure. Accordingly, depending upon the initial chemical composition of the TPU, the comminuted TPU of the subject disclosure may be a comminuted polyester-based TPU, a comminuted polyether-based TPU, or any blends thereof.

Cellular foams are typically processed by mixing liquid components in a mold under low pressure in the presence of a blowing agent to produce foam article. A blowing agent can eb a physical blowing agent or a chemical blowing agent.

The terminology “physical blowing agent” refers to blowing agents that do not chemically react with the isocyanate component and/or the isocyanate-reactive component. The physical blowing agent can be a gas or liquid. The liquid physical blowing agent typically evaporates into a gas when heated, and typically returns to a liquid when cooled. In certain embodiments, the physical blowing agent can also be a gas that is trapped within a polyurethane elastomer shell, wherein the gas expands under heat which causes the shell to grow. In certain embodiments, the physical blowing agent may be introduced via a masterbatch containing both the physical blowing agent and a polymer matrix composition such as ethylene vinyl acetate (EVA) or is simply admixed with the remainder of the components used in forming the polyurethane foam.

The liquid physical blowing agent, in certain aspects, evaporates into a gas when heated, and typically returns to a liquid when cooled. In certain aspects, the liquid physical blowing agent is a liquefied gas such as liquefied carbon dioxide or liquid nitrogen.

The terminology “chemical blowing agent” refers to blowing agents which chemically react with the isocyanate or with other components to release a gas for foaming. One specific, non-limiting example of a chemical blowing agent is water. Other nonlimiting examples of chemical blowing agents include citric acid or hydrogen carbonate which can also create carbon dioxide.

The blowing agent is typically present in the isocyanate-reactive component for forming the polyurethane foam in an amount of from about 0.5 to about 20 parts by weight, based on 100 parts by weight of total hydroxyl-functional polymer present in the isocyanate-reactive component used for forming the polyurethane foam.

As also noted above, the isocyanate-functional polymer component of the subject disclosure also includes an isocyanate component having isocyanate-functional groups as a reaction component that reacts with the isocyanate-reactive component. Suitable isocyanates for use in the isocyanate component include, but are not limited to, to those included in the pre-formed polyurethane article above (and others not specifically described above), including, aromatic or aliphatic isocyanate-group containing compounds (i.e., aromatic isocyanates or aliphatic isocyanates) such as methylene diphenyl diisocyanate (MDI), toluene diisocyanate (TDI), polymethylene polyphenylisocyanate (PMDI), hexamethylene diisocyanate (HDI), a uretonimine polymer, an isocyanate-terminated prepolymer, and any combinations thereof.

The isocyanate component for use in forming the isocyanate-functional polymer component typically has an average functionality of from about 1.5 to about 3.0, more typically from about 2.0 to about 2.8, and yet more typically about 2.7. The isocyanate component also typically has an NCO content varying from a few weight percent to around 50 weight percent, depending upon the isocyanate component. For aliphatic isocyanates, the NCO content may range from about 18 to 30 wt. %. For aromatic isocyanates, the NCO content may range from 25 to 50 wt. %. For isocyanate prepolymers the range may vary from 1 to 47 wt. %, more typically 1-29 wt. %. For hexamethylene diisocyanate (HDI), the isocyanate component typically has an NCO content of from about 20 to about 23.5 wt. %. For methylene diphenyl diisocyanate (MDI), the isocyanate component typically has an NCO content of from about 29 to about 34 wt. %. For toluene diisocyanate (TDI), the isocyanate component typically has an NCO content of from about 45 to about 50 wt. %. The isocyanate-terminated prepolymer, when comprising or otherwise present in the isocyanate component, is generally the reaction product of an isocyanate component (such as those described above) and an active hydrogen-containing species and is formed by various methods understood by those skilled in the art or can be obtained commercially from a manufacturer, a supplier, etc. The active hydrogen-containing species can alternatively be referred to as an isocyanate-reactive component having reactive groups (i.e., compounds or compositions having active hydrogen atoms) reactive with the isocyanate-functional groups of the isocyanate component.

In certain embodiments, the isocyanate component of the isocyanate-terminated prepolymer is selected from the group of methylene diphenyl diisocyanate (also sometimes referred to as diphenylmethane diisocyanate, MDI, or monomeric MDI), polymethylene polyphenyl diisocyanate (also sometimes referred to as polymeric diphenylmethane diisocyanate, polymeric MDI or PMDI), and combinations thereof. MDI exists in three isomers (2,2′-MDI, 2,4′-MDI, and 4,4′-MDI) however, the 4,4′ isomer (sometimes referred to as Pure MDI) is most widely used. For the purposes of the subject disclosure, the term “MDI” refers to all three isomers unless otherwise noted. In certain embodiments, the second isocyanate-terminated prepolymer comprises a blend of PMDI and quasi-prepolymers of 4,4′-methyldiphenyldiisocyanate.

The isocyanate-reactive component used for forming the isocyanate-terminated prepolymer is preferably a polymer that includes one or more hydroxyl groups (OH-functional groups), or more commonly referred to as a hydroxyl-functional polymer. The isocyanate component is a polymer that includes one or more isocyanate groups (NCO groups) that react with the hydroxyl groups to form carbamate (i.e., urethane) links.

In certain embodiments, the hydroxyl-functional polymer is a hydroxyl-functional polyether (i.e., hydroxyl-functional polyether-group containing polymers), while in other embodiments the hydroxyl-functional polymer is a hydroxyl-functional polyester (i.e., hydroxyl-functional polyester-group containing polymers). In yet other embodiments, the isocyanate-reactive component hydroxyl-functional polymer can be a mixture of a hydroxyl-functional polyether and a hydroxyl-functional polyester.

The hydroxyl-functional polyether used as one of the reactants in forming the isocyanate-terminated prepolymer are polyether polymers that include one or more hydroxyl-functional groups, typically at least two OH-functional groups. Accordingly, the hydroxyl-functional polyether are polyether polymers having one OH-functional group (i.e., a polyether monol), two OH-functional groups (i.e., a polyether diol), three OH-functional groups (i.e., a polyether triol), four OH-functional groups (i.e., a polyether tetrol), polyether-group containing polymers having more than four OH-functional groups, and combinations thereof. The hydroxyl functionality of these hydroxyl-functional polyethers is typically expressed in terms of an average functionality of all of the respective polymer chains present in the collective hydroxyl-functional polyether blend. Hydroxyl-functional polyethers having an average of two or more OH-functional groups per molecule are sometimes alternatively referred to as polyether polyols, which are typically formed as the polymeric reaction product of an organic oxide and an initiator compound containing two or more active hydrogen atoms. The active hydrogen compound in the presence of a base catalyst initiates ring opening and oxide addition, which is continued until the desired molecular weight is obtained. If the initiator has two active hydrogens, a diol result. If a trifunctional initiator such as glycerin is used, the oxide addition produces chain growth in three directions, and a triol results.

The hydroxyl-functional polyether can be any type of hydroxyl-functional polyether known in the art. The hydroxyl-functional polyether can be non-ethoxylated or ethoxylated. In addition, the hydroxyl-functional polyether can be short chain, low molecular weight hydroxyl-functional polyether having one or more OH-functional groups. Particularly suitable hydroxyl-functional polyether or polyethers for use in the polyurethanes include, but are not limited to, products obtained by the polymerization of a cyclic oxide, for example ethylene oxide (EO), propylene oxide (PO), butylene oxide (BO), or tetrahydrofuran in the presence of initiator compounds having one or more active hydrogen atoms. Suitable initiator compounds including a plurality of active hydrogen atoms for use in obtaining hydroxyl-functional polyethers include water, butanediol, ethylene glycol, propylene glycol (PG), diethylene glycol, triethylene glycol, dipropylene glycol, ethanolamine, diethanolamine, triethanolamine, toluene diamine, diethyl toluene diamine, phenyl diamine, diphenylmethane diamine, ethylene diamine, cyclohexane diamine, cyclohexane dimethanol, resorcinol, bisphenol A, glycerol, trimethylolpropane, 1,2,6-hexanetriol, pentaerythritol, and combinations thereof.

Other suitable hydroxyl-functional polyether or polyethers include polyether diols and triols, such as polyoxypropylene diols and triols and poly (oxyethyleneoxypropylene) diols and triols obtained by the simultaneous or sequential addition of ethylene and propylene oxides to di-or tri-functional initiators. Copolymers having oxyethylene contents of from about 5 to about 90% by weight, based on the weight of the polyether polyol component, of which the polyether polyols may be block copolymers, random/block copolymers or random copolymers, can also be used. Yet other suitable hydroxyl-functional polyethers include polytetramethylene ether glycols obtained by the polymerization of tetrahydrofuran.

Particularly suitable hydroxyl-functional polyether or polyethers for use include those based on a totally heteric (or random) EO (ethylene oxide), PO (propylene oxide) structure, or those having heteric, but uniform blocks of EO and PO, e.g., blocks comprising EO and blocks comprising PO. As yet another suitable example, the hydroxyl functional polyether can have heteric blocks and uniform blocks of EO and PO, e.g., blocks comprising all EO or PO and blocks comprising random EO, PO. Still further, in certain examples, the hydroxyl-functional polyether can be heteric or random copolymers of EO and PO which are end blocked with either EO or PO. One particularly suitable hydroxyl-functional polyether comprises a polyether-triol having ethyleneoxide terminal groups.

Suitable non-limiting commercial hydroxyl-functional polyether or polyethers having an average of two OH-functional groups per molecule, sometimes referred to as polyether diols, for use in forming the isocyanate-terminated prepolymers in the subject disclosure are based upon the propoxylation and/or ethoxylation of diethylene glycol, dipropylene glycol, ethylene glycol, or propylene glycol include Pluracol® P410R, 1010, 2010, 1062, and 1044, each commercially available from BASF Corporation of Florham Park, New Jersey. In particular, Pluracol® P410R, 1010, 2010, and 1044 are PO-containing hydroxyl-functional polyether diols, while Pluracol® 1062 is a PO-containing hydroxyl-functional polyether diols endcapped with EO.

Suitable non-limiting commercial hydroxyl-functional polyether or polyethers having an average of three OH-functional groups per molecule, sometimes referred to as polyether triols, for use in forming the isocyanate-terminated prepolymers of the subject disclosure are based on the propoxylation and/or ethoxylation of glycerin or trimethyolpropane include Pluracol® GP430, GP730, 4156, 2090, and 816, each commercially available from BASF Corporation of Florham Park, New Jersey. In particular, Pluracol® GP430 and GP730 are PO-containing hydroxyl-functional polyether triols, Also, Pluracol® 2090 and 816 are a PO-containing hydroxyl-functional polyether triol endcapped with EO, while Pluracol® 4156 is a pure heteric hydroxyl functional polyether triol.

Suitable non-limiting commercial hydroxyl-functional polyether or polyethers having an average of four OH-functional groups per molecule, sometimes referred to as polyether tetrols, propoxylation and/or ethoxylation of toluene diamine, ethylene diamine, and pentaerythritol for use in forming the isocyanate-terminated prepolymers of the subject disclosure include Pluracol® 735, 736 and PEP 500 and Quadrol, each commercially available from BASF Corporation of Florham Park, New Jersey. In particular, Pluracol® 735 and 736 toluene diamine-initiated hydroxyl-functional polyether polyols based on PO, Pluracol® PEP 500 is a pentaerythritol-initiated heteric, and Quadrol is an ethylene diamine-initiated hydroxyl-functional polyether polyols based on PO. One suitable non-limiting commercial higher hydroxyl-functional polyethers for use in forming the isocyanate-terminated prepolymers of the subject disclosure are based on sucrose, sorbitol or combinations thereof alone or in combination with other initiators is Pluracol® SG360 (based on sucrose and glycerin), commercially available from BASF Corporation of Florham Park, New Jersey. In certain of these embodiments, the hydroxyl-functional polyether or polyethers for use in forming the isocyanate-terminated prepolymers of the subject disclosure have a weight average molecular weight (Mw) ranging from 60 to 10,000, such as 180 to 6,500, g/mol, as measured by gel permeation chromatography (GPC) or nuclear magnetic resonance (NMR) previously calibrated using a calibration curve based on mono-dispersed polystyrene standards.

In certain aspects, a combination of two or more hydroxyl-functional polyethers for use in forming the isocyanate-terminated prepolymers can be used, with each one of the two or more hydroxyl-functional polyethers having the same or a different weight average molecular weight within the range of 60 to 10,000, such as 180 to 6,500, g/mol described above. Thus, for example, the hydroxyl-functional polyethers used may include a first hydroxyl-functional polyether having a weight average molecular weight ranging from 60 to 10,000,such as 180 to 6,500, g/mol and a second hydroxyl-functional polyether different from the first hydroxyl-functional polyether also having a weight average molecular weight ranging from 60 to 10,000, such as 180 to 6,500, g/mol. Representative examples of the two or more hydroxyl-functional polyethers include those described in the paragraphs above. In even further embodiments, in addition to the hydroxyl-functional polyether, the isocyanate-reactive component used in forming the isocyanate-terminated prepolymers further includes a styrene-acrylonitrile graft polyol.

In certain embodiments, in addition to or in place of the hydroxyl-functional polyether, the isocyanate-reactive component used in forming the isocyanate-terminated prepolymers may be in the form of another hydroxyl-functional polymer, including but not limited to hydroxyl-functional polyesters and hydroxyl-functional acrylics.

Suitable hydroxyl-functional polyesters for use in forming the isocyanate-terminated prepolymers, include, for example polyester polymers that include one or more hydroxyl-functional groups, typically at least two OH-functional groups. Accordingly, the hydroxyl-functional polyesters are polyester polymers having one OH-functional group (i.e., a polyester monol), two OH-functional groups (i.e., a polyester diol), three OH-functional groups (i.e., a polyester triol), four OH-functional groups (i.e., a polyester tetrol), polyether-group containing polymers having more than four OH-functional groups, and combinations thereof. Hydroxyl-functional polyesters having an average of two or more OH-functional groups per molecule are sometimes alternatively referred to as polyester polyols,

Suitable hydroxyl-functional polyesters include, but are not limited to, aromatic group containing hydroxyl-functional polyesters, hydroxyl-terminated reaction products of polyhydric alcohols, such as ethylene glycol, propylene glycol, diethylene glycol, 1,4butanediol, neopentylglycol, 1,6-hexanediol, cyclohexane dimethanol, glycerol, trimethylolpropane, pentaerythritol or polyether polyols or mixtures of such polyhydric alcohols, and polycarboxylic acids, especially dicarboxylic acids or their ester-forming derivatives, for example succinic, glutaric and adipic acids or their dimethyl esters sebacic acid, phthalic anhydride, tetrachlorophthalic anhydride or dimethyl terephthalate or mixtures thereof. Polyester polyols obtained by the polymerization of lactones, e.g., caprolactone, in conjunction with a polyol, or of hydroxy carboxylic acids, e.g., hydroxy caproic acid, may also be used.

Suitable polyesteramides polyols for use in forming the isocyanate-terminated prepolymers may be obtained by the inclusion of aminoalcohols such as ethanolamine in polyesterification mixtures. Suitable polythioether polyols include products obtained by condensing thiodiglycol either alone or with other glycols, alkylene oxides, dicarboxylic acids, formaldehyde, aminoalcohols or aminocarboxylic acids. Suitable polycarbonate polyols include products obtained by reacting diols such as 1,3propanediol, 1,4-butanediol, 1,6-hexanediol, diethylene glycol or tetraethylene glycol with diaryl carbonates, e.g., diphenyl carbonate, or with phosgene. Suitable polyacetal polyols include those prepared by reacting glycols such as diethylene glycol, triethylene glycol or hexanediol with formaldehyde. Other suitable polyacetal polyols may also be prepared by polymerizing cyclic acetals. Suitable polyolefin polyols include hydroxy-terminated butadiene homo-and copolymers and suitable polysiloxane polyols include polydimethylsiloxane diols and triols.

In addition, lower molecular weight hydroxyl-functional compounds may also be utilized in forming the isocyanate-terminated prepolymers, such as ethylene glycol, di ethylene glycol, propylene glycol, dipropylene glycol, butane diol, glycerol, trime thylpropane, triethanolamine, pentaerythritol, sorbitol, and combinations thereof. The isocyanate-reactive component for use in forming the isocyanate-terminated prepolymers may also include one or more catalysts. The catalyst is typically present in the isocyanate-reactive component to catalyze the reaction between the isocyanate component and the isocyanate-reactive component.

The isocyanate-reactive component for use in forming the isocyanate-terminated prepolymers may also include various additional additives. Suitable additives include, but are not limited to, anti-foaming agents, processing additives, plasticizers, chain terminators, surface-active agents, flame retardants, antioxidants, water scavengers, fumed silicas, dyes or pigments, ultraviolet light stabilizers, fillers, thixotropic agents, silicones, amines, transition metals, and combinations thereof. The additive may be included in any amount as desired by those of skill in the art. For example, a pigment additive allows the polyurethane elastomer composition to be visually evaluated for thickness and integrity and can provide various marketing advantages. Suitable hydroxyl-functional acrylics for use in forming the isocyanate-terminated prepolymers are obtained by free-radical polymerization of acrylate and methacrylate esters and styrene (such as ethyl acrylates (EA) or butyl acrylates (BA), acrylic acid (AA), methyl methacrylate (MMA), or styrene (ST)). Hydroxyl functionality is introduced by adding ethylenically unsaturated monomers having at least one free hydroxyl group, typically hydroxy-functional acrylates (HFAs) such as 2-hydroxyethyl acrylates (HEA) or 4-hydroxybutyl acrylates (HBA), to the monomer blend. One exemplary 100% solids acrylic-modified polyether polyol in Joncryl 569, commercially available from BASF Corporation of Florham Park, New Jersey, having a hydroxyl number of 140 mg KOH/g.

Specific examples of suitable isocyanate-terminated prepolymers, for purposes of the subject disclosure, are commercially available from BASF Corporation of Florham Park, NJ, under the trademark Lupranate®, such as Lupranate® MP102. It is to be appreciated that the system can include a combination of two or more of the aforementioned isocyanate-terminated prepolymers.

Exemplary diisocyanates that may be used in forming the polycarbodiimide include, but are not limited to: MDI (in any the three isomers (2,2′-MDI, 2,4′-MDI, and 4,4′MDI); m-phenylene diisocyanate; 2,4-toluene diisocyanate; 2,6-toluene diisocyanate; hexamethylene diisocyanate; 1,4-phenylene diisocyanate; tetramethylene diisocyanate; cyclohexane-1,4-diisocyanate; hexahydrotoluene diisocyanate; methylenediisocyanate; 2,6-diisopropylphenyl isocyanate; m-xylylene diisocyanate; dodecyl isocyanate; 3, 3′-dichloro-4,4′-diisocyanato-1,1′-bi phenyl; 1,6-diisocyanato-2,2,4trimethylhexane; 3,3′-dimethoxy4,4′-biphenylene diisocyanate; 2,2diisocyanatopropane; 1,3-diisocyanatopropane; 1,4diisocyanatobutane; 1,5diisocyanatopentane; 1,6-diisocyanatohexane; 2,3-diisocyanatotoluene;

2,4diisocyanatotoluene; 2,5-diisocyanatotoluene; 2,6-diisocyanatotoluene; isophorone diisocyanate; hydrogenated methylene bis (phenylisocyanate); naphthalene-1,5diisocyanate; 1-methoxyphenyl-2,4-diisocyanate;1,4-diisocyanatobutane; 4,4′biphenylene diisocyanate; 3,3′-dimethyldiphenylmethane4,4′-diisocyanate; 4,4′,4″triphenylmethane triisocyanate; toluene-2,4,6-triisocyanate; 4,4′dimethyldiphenylmethane-2,2′,5,5′-tetraisocyanate; poly methylene polyphenylene polyisocyanate; or a mixture of any two or more thereof. In a preferred embodiment, the diisocyanate is 2,4-toluene diisocyanate, 2,6-toluene diisocyanate, or a mixture of 2,4 and 2,6-toluene diisocyanate.

In certain aspects, the isocyanate component for forming the polycarbodiimide comprises MDI (in any the three isomers (2,2′-MDI, 2,4′-MDI, and 4,4′-MDI). Alternatively, the isocyanate component may comprise a blend of two or all three of these three MDI isomers, i.e., the isocyanate component may comprise at least two of 2,2′MDI, 2,4′-MDI, and 4,4′-MDI.

In certain other embodiments, the isocyanate component for forming the polycarbodiimide comprises toluene diisocyanate (TDI). The isocyanate component may comprise either isomer of toluene diisocyanate (TDI), i.e., the isocyanate component may comprise 2,4-toluene diisocyanate (2,4-TDI) or 2,6-toluene diisocyanate (2,6TDI). Alternatively, the isocyanate component may comprise a blend of these isomers, i.e., the isocyanate component may comprise both 2,4-toluene diisocyanate (2,4-TDI) and 2,6-toluene diisocyanate (2,6-TDI). One specific example of a commercially available isocyanate component suitable for the purposes of the subject disclosure is Lupranate® T-80, which is commercially available from BASF Corporation of Florham Park, New Jersey. Notably, Lupranate® T-80 comprises a blend of 2,4-toluene diisocyanate (2,4-TDI) and 2,6-toluene diisocyanate (2,6-TDI). In certain embodiments, the isocyanate component consists essentially of, or consists of, TDI. Generally, the isocyanate component comprises TDI in an amount of from greater than 95, alternatively greater than 96, alternatively greater than 97, alternatively greater than 98, alternatively greater than 99, percent by weight based on the total weight of isocyanate present in the isocyanate component.

In one embodiment, the present invention provides a polyurethane composition including toluene-2,4-diisocyanate and toluene-2,6-diisocyanate.

Polyurethane (PUR or PU) refers to a class of polymers composed of organic units joined by carbamate (urethane) links. In contrast to other common polymers such as polyethylene and polystyrene, polyurethane is produced from a wide range of starting materials (monomers) and is therefore a class of polymers, rather than a distinct compound. This chemical variety allows for polyurethanes with very different physical properties, leading to an equally wide range of different applications including: rigid and flexible foams, varnishes and coatings, adhesives, electrical potting compounds, and fibers such as spandex and PUL. Of these, foams are the largest single application.

Polyurethane polymers are traditionally and most commonly formed by reacting a di or triisocyanate with a polyol. Since polyurethanes contain two types of monomers, which polymerize one after the other, they are classed as alternating copolymers. Both the isocyanates and polyols used to make polyurethanes contain, on average, two or more functional groups per molecule. The compositions described herein include toluene diisocyanate (TDI) as the diisocyanate of the PU composition.

Toluene diisocyanate or TDI is an organic compound with the formula CH₃C₆H₃(NCO)₂. Two of the six possible isomers are commercially important: 2,4-TDI (CAS: 584-84-9) and 2,6-TDI (CAS: 91-08-7). 2,4-TDI is produced in the pure state, but TDI is often marketed as 80/20 and 65/35 mixtures of the 2,4 and 2,6 isomers respectively. The isocyanate functional groups in TDI react with hydroxyl groups to form carbamate (urethane) links. The two isocyanate groups in TDI react at different rates: The 4-position is approximately four times more reactive than the 2-position. 2,6-TDI is a symmetrical molecule and thus has two isocyanate groups of similar reactivity, similar to the 2-position on 2,4-TDI. However, since both isocyanate groups are attached to the same aromatic ring, reaction of one isocyanate group will cause a change in the reactivity of the second isocyanate group.

The isocyanate component of the composition describes herein includes a blend of 2,4-toluene diisocyanate (2,4-TDI) and 2,6-toluene diisocyanate (2,6TDI) isomers.

In one aspect, the composition includes between about 50% and 80% of toluene-2,4-diisocyanate. For example, the composition includes about 50, 55, 60, 65, 70, 75 or 80% of toluene-2,4-diisocyanate.

In another aspect, the composition includes between about 10% and 20% of toluene-2,6-diisocyanate. For example, the composition includes about 10, 15 or 20% of toluene-2,6-diisocyanate.

In some aspects, the composition includes between about 50% and 75% of toluene-2,4-diisocyanate and between about 10% and 15% of toluene-2,6-diisocyanate; between about 50% and 75% of toluene-2,4-diisocyanate and between about 15% and 20% of toluene-2,6-diisocyanate; or between about 60% and 80% of toluene-2,4-diisocyanate and between about 10% and 20% of toluene-2,6-diisocyanate.

In another embodiment, the compositions described herein are for use for the production of a polyurethane pre-polymer.

As used herein, the term “pre-polymer” or “polyurethane pre-polymer” refers to polymers that are used for the preparation of production of polyurethane articles. As detailed below, the composition described herein, including a blend of 2,4-toluene diisocyanate (2,4-TDI) and 2,6-toluene diisocyanate (2,6TDI) isomers are used for the conversion of polyurethane articles, such as foams, into polyurethane pre-polymer that can in then be used for the production of secondary polyurethane articles. Pre-polymer also includes TDI mixed with polyol.

In various aspects, the toluene diisocyanate compositions described herein are liquid compositions, that are used to convert polyurethane articles into pre-polymer. In many aspects, the polyurethane articles comprise solid polyurethane articles, and the polyurethane pre-polymer obtained is a liquid polyurethane pre-polymer.

In one aspect the pre-polymer is used for the production of industrial chemicals and/or industrial polymers.

As used herein, the terms “industrial chemicals” and “industrial polymers” are meant to refer to any product that can be generated using the pre-polymers obtained using the compositions described herein. Non limiting examples of industrial chemicals and industrial polymer include polyurethanes, primarily for the production of flexible foam for use in bedding and furniture, carpet underlay, as well as packaging; coatings; sealants; adhesives; and elastomers.

In one embodiment, the present invention provides a method of producing a polyurethane pre-polymer including: a) processing and/or densifying a pre-formed polyurethane article, b) pre-heating a toluene diisocyanate composition at a temperature ranging from about 130 to 165° C., and c) contacting the processed and/or densified pre-formed polyurethane article with the toluene diisocyanate composition, thereby producing a polyurethane pre-polymer.

As used herein, the terms “processing” and “densifying” of the article are meant to refer to any process that is applied to the article that results in an increase in the article density, a decrease in the article volume, or a combination thereof. Examples of methods to increase an article density include but are not limited to grinding, compaction, compression, milling, crushing, squeezing, and the like.

The method described herein relies on the contacting of a pre-formed polyurethane article with a TDI composition. The chemical transformation is optimized by pre-heating the TDI composition prior to adding the polyurethane articles. By optimizing, it is meant that the chemical reaction is faster and/or more efficient. In some aspects, pre-heating is at a temperature ranging from about 130° C. to 165° C. For example, the pre-heating temperature is about 125, 130, 135, 140, 145, 150, 155, 160, 165 or 170° C. In other examples, the pre-heating temperature ranges from about 130-135° C., 135-140° C., 140-145° C., 145-150° C., 150-155° C., 155-160° C., 160-165° C., 130-140° C., 140-150° C., 150-160° C., 135-145° C., 145-155° C., 155-165° C., 130-145° C., 145-160° C., 135-150° C., 150-165° C., 130-150°° C., 135-155° C., 140-160° C., 145-165° C., 130-155° C., 135-160° C., 140-165° C., 130-160° C., or 135-165° C.

In various aspects, the pre-heating temperature ranges from about 160 to 165° C. For example, the pre-heating temperature includes 159° C., 160° C., 161° C., 162°° C., 163° C., 164° C., 165° C. and 166° C.

In other aspects, increasing the pre-heating temperature decreases processing time.

The processing step and the pre-heating steps are independent steps that can be done at a same time, or one prior to the other regardless of the order (prior to or after). The method however requires that the contacting steps include the contacting of a processed/densified article with a pre-heated composition.

In some aspects, the processing and/or densifying step occurs prior to, after, or concurrently with the pre-heating step.

In one aspect, the polyurethane composition includes between about 50% and 75% of toluene-2,4-diisocyanate and between about 10% and 15% of toluene-2,6-diisocyanate. In another aspect, the polyurethane composition includes between about 50% and 75% of toluene-2,4-diisocyanate and between about 15% and 20% of toluene-2,6-diisocyanate. In an additional aspect, the polyurethane composition includes between about 60% and 80% of toluene-2,4-diisocyanate and between about 10% and 20% of toluene-2,6-diisocyanate.

In one aspect, the pre-formed polyurethane article is a polyurethane foam.

As used herein, the term “polyurethane foam” is meant to include flexible polyurethane foam and rigid polyurethane foam. As used herein, “flexible polyurethane foam” refers to a particular class of polyurethane foam and stands in contrast to rigid polyurethane foam. Flexible polyurethane foam is generally porous, having open cells, whereas rigid polyurethane foam is generally non-porous, having closed cells and no rubber-like characteristics. In particular, flexible polyurethane foam is a flexible cellular product which will not rupture when a specimen 200 mm by 25 mm by 25 mm is bent around a 25-mm diameter mandrel at a uniform rate of 1 lap in 5 seconds at a temperature between 18 and 29 degrees Celsius, as defined by ASTM D3574-03.

Flexible polyurethane foams are typically produced from hydroxyl functional polymers having weight average molecular weights from about 1,000 to about 10,000 g/mol and hydroxyl numbers from about 10 to about 200 mg KOH/g. In contrast, rigid polyurethane foams are typically produced from hydroxyl-functional polymers having weight average molecular weights from about 250 to about 700 g/mol and hydroxyl numbers from about 300 to about 700 mg KOH/g. Moreover, flexible polyurethane foams generally include more urethane linkages as compared to rigid polyurethane foams, whereas rigid polyurethane foams may include more isocyanurate linkages as compared to flexible polyurethane foams. Further, flexible polyurethane foams are typically produced from low-functionality (f) initiators, i.e., f<4, such as dipropylene glycol (f=2) or glycerine (f=3). By comparison, rigid polyurethane foams are typically produced from hydroxyl-functional polymers having high-functionality initiators, i.e., f>4, such as Mannich bases (f=4), toluenediamine (f−4), sorbitol (f=6), or sucrose (f=8). Additionally, as known in the art, flexible polyurethane foams are typically produced from glycerin-based hydroxyl-functional polymers, whereas rigid polyurethane foams are typically produced from polyfunctional hydroxyl-functional polymers that create a three-dimensional cross-linked cellular structure, thereby increasing the stiffness of the rigid polyurethane foam. Finally, although both flexible polyurethane foams and rigid polyurethane foams include cellular structures, flexible polyurethane foams typically include more open cell walls, which allow air to pass through the flexible polyurethane foam when force is applied as compared to rigid polyurethane foams. As such, flexible polyurethane foams typically recover shape after compression. In contrast, rigid polyurethane foams typically include more closed cell walls, which restrict air flow through the rigid polyurethane foam when force is applied.

In one aspect, the polyurethane foam is selected from the group consisting of microcellular foam, semi-rigid foam, molded foam, and any combination thereof. In some aspects, the foam includes polyols having a molecular weight ranging from about 1000 to 3600 Da.

In other aspects, the processing and/or densifying the foam includes grinding the foam to obtain shredded foam.

Foam is a low-density material that also has large volume compared to its density. In order to optimize contact surface of the polyurethane composition with the foam, without requiring excessive volume of polyurethane composition, the method described herein provides that the foam is processed and/or densified prior to being contacted with the polyurethane composition (e.g., the pre-heated polyurethane composition). As used herein, the term “processing” of the foam is meant to refer to any process that is applied to the foam that results in an increase in the foam density, a decrease in the foam volume, or a combination thereof. Examples of methods to increase foam density include but are not limited to grinding, compaction, compression, milling, crushing, squeezing, and the like.

In various aspects, processing and/or densifying comprises using a grinder, a processor, a shredder, a granulator, a crusher, a compactor or a miller.

In another aspect, the shredded foam fragments have a size ranging from about 500 μm to 5 mm.

Increase the foam density or decreasing the foam volume (e.g., grinding) includes generating fragments of foam that are smaller in size than the initial foam piece. The method producing polyurethane pre-polymer described herein relies on the contacting of the polyurethane composition with foam fragments, such that the surface of foam that is in contact with the composition is optimized. The term “foam fragment” as used herein is meant to include fragments having a size ranging from about 500 μm to 5 mm. For example, the foam fragment is about 400 μm, 500 μm, 600 μm, 700 μm, 800 μm, 900 μm, 1 mm, 2 mm, 3 mm, 4 mm, 5 mm, 6 mm or more.

In some aspects, the shredded foam fragments have a size of about 1 mm.

In one aspect, the production in a continuous process.

The term “continuous” as used herein is meant to refer to a process that is not in batches. The method described herein allows for the continuous (i.e., without interruption) production of the polyurethane pre-polymer. Generally, the pre-formed polyurethane article was initially generated using polyurethane pre-polymers, and the methods described herein allows for the transformation of pre-formed solid polyurethane articles (i.e., foam) into liquid polyurethane pre-polymers that have the same or substantially the same properties as the polyurethane pre-polymers used to generate the foam. As such, the polyurethane pre-polymer produced by the methods described herein can be in turn used to generate new polyurethane articles.

The present disclosure relies on the discovery of means to optimize such process, such that it can be done continuously without the need for interruption to renew material. As long as the polyurethane composition (and then the mixture of the polyurethane composition/polyurethane article) is maintained at the pre-heating temperature, foam fragments can be added to the composition to produce polyurethane pre-polymer from the pre-formed solid polyurethane article.

In another aspect, contacting includes contacting about 1-30% w/w polyurethane article with the TDI composition. In various aspects, the contacting includes a contacting about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30% w/w polyurethane article with the TDI composition.

The methods described herein allows for a continuous process, i.e., the possibility to continuously add polyurethane article fragments to the TDI composition to produce polyurethane pre-polymer. To maintain the continuousness of the process, the amount of polyurethane article should not exceed about 35% of the amount of polyurethane composition. The optimal reaction conditions allowing the continuousness of the reaction include a weight/weight ratio of foam: polyurethane composition that ranges from about 1-30% w/w. For example, the optimal reaction conditions comprise 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30% 35% w/w or more of polyurethane article.

In one aspect, the method further includes stirring the pre-formed polyurethane article and the heated polyurethane composition.

Stirring the pre-formed polyurethane article fragments and the heated composition can be used to maintain the optimal contact between the article fragments and the heated composition throughout the processing time.

In another aspect, the temperature used for pre-heating the toluene diisocyanate composition (i.e., the pre-heating temperature) is maintained throughout the contacting step. In many aspects, the contacting temperature (i.e., the temperature throughout the reaction occurring between the processed and/or densified pre-formed polyurethane article and the toluene diisocyanate composition) ranges from about 130°° C. to 165° C. For example, the contacting temperature is maintained at about 130-135° C., 135-140° C., 140-145° C., 145-150° C., 150-155° C., 155-160° C., 160-165° C., 130-140°° C., 140-150° C., 150-160° C., 135-145° C., 145-155° C., 155-165° C., 130-145° C., 145-160° C., 135-150° C., 150-165° C., 130-150° C., 135-155° C., 140-160° C., 145-165° C., 130-155° C., 135-160° C., 140-165° C., 130-160° C., or 135-165° C.

In other examples, the contacting temperature is about 125, 130, 135, 140, 145, 150, 155, 160, 165 or 170° C. In various aspects, the contacting temperature ranges from about 160 to 165° C. For example, the contacting temperature includes 159° C., 160° C., 161° C., 162° C., 163° C., 164° C., 165° C. and 166° C.

In one aspect, the method further includes adding a catalyst after step (b).

In a further embodiment, the polyurethane pre-polymer produced by the method described herein is used for the production of industrial chemicals and/or industrial polymers.

The polyurethane pre-polymer produced by the method described herein is preferably in liquid form at room temperature and has a known isocyanate-functional group content (NCO content), based upon the total weight of the isocyanate component included in the mixture.

In still further aspects, the method for forming the isocyanate-functional pre-polymer may optionally include the step of filtering, or otherwise removing, the insoluble particles or other materials that may remain in the isocyanate functional pre-polymer component after the completion of the reaction (as evidenced by the NCO content reduction). These insoluble particles or materials, which are described above, generally do not affect the subsequent use of the formed isocyanate functional pre-polymer component in forming new polyurethane articles or new polyurethane foam articles but are desirable for removal in order to improve the aesthetic appearance of any new polyurethane articles or new polyurethane foam articles.

As noted above, the pre-polymer described herein can be used to produce industrial chemicals and/or industrial polymers such as new polyurethane articles, specifically new polyurethane foam articles, that are formed by including the isocyanate-functional pre-polymer component, as formed above, as at least a portion of the isocyanate component.

The term “new”, as used in relation to “new polyurethane articles” and “new polyurethane foam articles”, refers to the reaction product formed in the subject disclosure and serves to distinguish from the recycled polyurethane articles described above.

The new polyurethane articles of the subject disclosure, and associated new polyurethane foam articles, are formed as the reaction product of the isocyanate-functional polymer component according to any embodiment described above; a second isocyanate component having isocyanate-functional groups; and an isocyanate-reactive component having hydroxyl-functional groups reactive with the isocyanate-functional groups of the isocyanate-functional polymer component and the second isocyanate component.

The method for forming the new polyurethane article of the subject disclosure includes: forming the isocyanate-functional pre-polymer component as described above; providing a second isocyanate component the same or different from the first isocyanate component (i.e., the isocyanate component used in forming the isocyanate-functional polymer component described above); providing an isocyanate-reactive component having hydroxyl-functional groups reactive the isocyanate-functional groups of the isocyanate-functional polymer component and the second isocyanate component; forming a second mixture by mixing the provided second isocyanate component and the provided second isocyanate-functional polymer component and the isocyanate-reactive component; and reacting the isocyanate-functional groups of the isocyanate-functional polymer component and the second isocyanate component with the hydroxyl-functional groups of the isocyanate-reactive component to form the polyurethane elastomer. The method for forming the new polyurethane foam articles include wherein the reaction product is formed in the presence of a blowing agent, and thus the resultant structure of the new polyurethane foam article is formed as a cellular structure having open cells formed therewithin.

Suitable isocyanates for use as the second isocyanate component are the same as those described above for use in forming the isocyanate-functional polymer component or were initially utilized in forming the recycled polyurethane article and include, but are not limited to, aromatic or aliphatic isocyanate-group containing compounds (i.e., aromatic isocyanates or aliphatic isocyanates) such as methylene diphenyl diisocyanate (MDI), toluene diisocyanate (TDI), polymethylene polyphenylisocyanate (PMDI), hexamethylene diisocyanate (HDI), a uretonimine polymer, an isocyanate-terminated prepolymer, and any combinations thereof. Similar to above, the second isocyanate component typically has an average functionality of from about 1.5 to about 3.0, more typically from about 2.0 to about 2.8, and yet more typically about 2.7. In certain embodiments, the second isocyanate component is the same composition as the isocyanate component used to form the isocyanate-functional polymer component. In other embodiments, the composition of second isocyanate component is different than the composition of the isocyanate component used to form the isocyanate-functional polymer component but is selected from any of the isocyanate com-ponents described above. Similarly, the isocyanate-reactive component having hydroxyl-functional groups for use in forming the new polyurethane article, or new polyurethane foam article, can be selected from the same isocyanate-reactive component having hydroxyl-functional groups described above for forming the isocyanate-prepolymer. In these embodiments, the isocyanate-reactive component includes hydroxyl-functional groups (OH) that can react with the isocyanate-functional groups present in the isocyanate-functional polymer component and in the second isocyanate component.

In certain aspects, the ratio of isocyanate-functional groups of the isocyanate-functional polymer component and the second isocyanate component to the hydroxyl-functional groups of the isocyanate-reactive component (i.e., the NCO:OH ratio) ranges from 0.90:1 to 3.0:1.

For new flexible polyurethane articles, such as new flexible polyurethane foam articles, the NCO:OH ratio ranges from 0.90:1 to 1.05:1. For new rigid polyurethane articles, such as new rigid polyurethane foam articles, the NCO:OH ratio ranges from 1.05:1 to 3.0:1. For new semi-rigid polyurethane articles, such as new semi-rigid polyurethane foam articles, the NCO:OH ratio generally is around 1.05:1. In still further embodiments, the isocyanate-functional polymer component includes from 1 to 99 weight percent of the total combined weight of the isocyanate-functional polymer component and the second isocyanate component.

In further aspects, the new polyurethane article, or new polyurethane foam article, may include an additional component selected from the group consisting of chain extenders, amines, catalysts, tin catalysts, crosslinkers (i.e., curing agents), adhesion promotors, wetting agents, and any combination thereof.

The chain extender used to form the new polyurethane article, or new polyurethane foam article, according to the subject disclosure suitably comprises compounds having 2 or more active hydrogens and molecular weights ranging from 60 g/mol to 400 g/mol, such as from 60 g/mol to 200 g/mol. Suitable chain extenders having 2 or more active hydrogens include, for example, diols and higher hydroxyl-functional compounds or compositions such as 1,4-butanediol, ethylene glycol, diethylene glycol, propylene glycol, butylene glycol, 1,4-butylene glycol, butenediol, butynediol, xylylene glycols, amylene glycols, 1,5-pentylene glycol, methylpentanediol, 1,6-hexylene glycol, neopentyl glycol, trimethylolpropane, hydroquinone ether alkoxylate, resorcinol ether alkoxylate, glycerol, pentaerythritol, diglycerol, dextrose, 1,4-phenylene-bis--hydroxy ethyl ether, 1,3-phenylene-bis--hydroxy ethyl ether, bis-(hydroxy-methyl-cyclohexane), hexanediol, thiodiglycol, and a 1,4:3,6 dianhydrohexitol such as isomannide; isosorbide and isoidide; aliphatic polyhydric amines such as ethylenediamine, hexamethylenediamine, and isophorone diamine; and aromatic polyhydric amines such as methylene-bis (2-chloroaniline), methylenebis (dipropylaniline), diethyl-toluenediamine, trimethylene glycol di-p-aminobenzoate; alkanolamines such as diethanolamine, triethanolamine and diisopropanolamine.

In certain aspects, the chain extender is a diol, such as the one or more diols from the list as provided above. If higher functional polyols, such as triols, are included, they are typically introduced in combination with the diols as provided above and in low relative amounts to limit crosslinking and prevent the resultant new polyurethane article or new polyurethane foam article from becoming too brittle.

The isocyanate-reactive component used to form the new polyurethane article, or new polyurethane foam article, may also include one or more amines. Any amine known in the art may be utilized, and in certain instances may also be described as a chain extender. Suitable amines that could be considered a chain extender include diamines including ethylene diamine, propylene diamine, butylene diamine, hexa-methylene diamine, cyclohexalene diamine, phenylene diamine, tolylene diamine, xylylene diamine, 3,3′-dichlorobenzidine, and 3,3′-dinitrobenzidine; alkanol amines such as ethanol amine, aminopropyl alcohol, 2,2-dimethyl propanol amine, 3-aminocyclohexyl alcohol, and p-aminobenzyl alcohol; and combinations thereof. In further embodiments, the amine may be chosen from MDA, TDA, ethylene-, propylene-butylene-, pentane-, hexane-, octane-, decane-, dodecane-, tetradecane-, hex-adecane-, octadecanediamines, Jeffamines-200,-400,-2000,-5000, hindered secondary amines like Unilink 4200, Curene 442, Polacure 740, Ethacure 300, Lonzacure M-CDEA, Polyaspartics, 4,9 Dioxadodecan-1, 12-diamine, and combinations thereof. In other embodiments, the amine is chosen from Lupragen® API-N-(3-Aminopropyl) imidazole, Lupragen® DMI-1,2-Dimethylimidazole, Lupragen® DMI-1,2-Dimethylimidazole, Lupragen® N 100-N,N-Dimethylcyclohexylamine, Lupragen® N 101-Dimethylethanolamine, Lupragen® N 103-N,N-Dimethylbenzylamine, Lupragen® N 104-N-Ethylmorpholine, Lupragen® N 105-N-Methylmorpholine, Lupragen® N 106-2,2′-Dimorpholinodiethylether, Lupragen® N 107-Dimethylami-noethoxyethanol, Lupragen® N 201-TEDA in DPG, Lupragen® N 202-TEDA in BDO, Lupragen® N 203-TEDA in MEG, Lupragen® N 204-N,N′-Dimethylpiperazine, Lupragen® N 205-Bis (2-dimethylaminoethyl) ether, Lupragen® N 206-Bis (2-dimethylaminoethyl) ether, Lupragen® N 301-Pentamethyldiethylene-triamine, Lupragen® N 301-Pentamethyldiethylenetriamine, Lupragen® N 400-Trimethylaminoethylethanolamine, Lupragen® N 500-Tetramethyl-1,6-hexandiamine, Lupragen® N 500-Tetramethyl-1,6-hexanediamine, Lupragen® N 600-S-Triazine, Lupragen® N 700-1,8-Diazabicyclo-5,4,0-undecene-7, Lupragen® NMI-N-Methylimidazole, and combinations thereof. The isocyanate-reactive component used to form the new polyurethane article, or new polyurethane foam article, may also include one or more catalysts. The catalyst is typically present in the isocyanate-reactive component to catalyze the reaction between the isocyanate component (including the isocyanate-functional polymer component and the second isocyanate component) and the isocyanate-reactive component. That is, isocyanate-reactive component typically includes a “polyurethane catalyst” which catalyzes the reaction between an isocyanate-functional group of the isocyanate-functional polymer component and the second isocyanate component and the hydroxyl-functional group of the isocyanate reactive group, including a hydroxyl group from the polydiene polyol.

It is to be appreciated that the catalyst is typically not consumed in the exothermic reaction between the isocyanate component (including the isocyanate-functional polymer component and the second isocyanate component) and the isocyanate-reactive component. More specifically, the catalyst typically participates in, but is not consumed in, the exothermic reaction.

The catalyst may include any suitable catalyst or mixtures of catalysts known in the art, including many of those described above with respect to forming the isocyanate-terminated prepolymers. Examples of suitable catalysts include, but are not limited to, gelation catalysts, e.g., amine catalysts in dipropylene glycol; blowing catalysts, e.g., bis (dimethylaminoethyl) ether in dipropylene glycol; and metal catalysts, e.g., organo-tin compounds, organo-bismuth compounds, organo-lead compounds, etc. This catalyst may be any in the art. In one embodiment, the isocyanate catalyst is an amine catalyst. In another embodiment, the isocyanate catalyst is an organometallic catalyst.

The isocyanate catalyst may be or include a tin catalyst. Suitable tin catalysts include, but are not limited to, tin (II) salts of organic carboxylic acids, e.g., tin (II) acetate, tin (II) octoate, tin (II) ethylhexanoate and tin (II) laurate. In one embodiment, the isocyanate catalyst is or includes dibutyltin dilaurate, which is a dialkyltin (IV) salt of an organic carboxylic acid. Specific examples of non-limiting isocyanate catalysts are commercially available from Air Products and Chemicals, Inc. of Allentown, PA, under the trademark DABCOR. The isocyanate catalyst can also include other dial-kyltin (IV) salts of organic carboxylic acids, such as dibutyltin diacetate, dibutyltin maleate and dioctyltin diacetate.

Examples of other suitable but non-limiting isocyanate catalysts include iron (II) chloride; zinc chloride; lead octoate; tris (dialkylaminoalkyl)-s-hexahydrotriazines including tris (N,N-dimethylaminopropyl)-s-hexahydrotriazine; tetraalkylammonium hydroxides including tetramethylammonium hydroxide; alkali metal hydroxides including sodium hydroxide and potassium hydroxide; alkali metal alkoxides including sodium methoxide and potassium isopropoxide; and alkali metal salts of long-chain fatty acids having from 10 to 20 carbon atoms and/or lateral OH groups.

Further examples of other suitable but non-limiting isocyanate catalysts include N,N,N-dimethylaminopropylhexahydrotriazine, potassium, potassium acetate, N,N,N-trimethyl isopropyl amine/formate, and combinations thereof. A specific example of a suitable trimerization catalyst is commercially available from Air Products and Chemicals, Inc. under the trademark POLYCAT®.

Yet further examples of other suitable but non-limiting isocyanate catalysts include dimethylaminoethanol, dimethylaminoethoxyethanol, triethylamine, N,N, N′, N′-tetramethylethylenediamine, N,N-dimethylaminopropylamine, pentamethyldipropylenetriamine, tris (dimethylaminopropyl) amine, N,N-dimethylpiperazine, tetramethylimino-bis (propylamine), dimethylbenzylamine, trime-thylamine, triethanolamine, N,N-diethyl ethanolamine, N-methylpyrrolidone, N-methylmorpholine, N-ethylmorpholine, bis (2-dimethylamino-ethyl) ether, N,N-dimethylcyclohexylamine (DMCHA), N,N,N′,N′,N″-pentamethyldiethylenetriamine, 1,2-dimethylimidazole, 3-(dimethylamino) propylimidazole, and combinations thereof. In various embodiments, the isocyanate catalyst is commercially available from Air Products and Chemicals, Inc. under the trademark POLYCAT®. The isocyanate catalyst may include any combination of one or more of the aforementioned catalysts. In still other embodiments, the catalyst is chosen from DABCO TMR, DABCO TMR-2, DABCO HE, DABCO 8154, PC CAT DBU TA 1, PC CAT Q1, Polycat SA-1, Polycat SA-102, salted forms, and/or combinations thereof.

In other aspects, the catalyst is chosen from dibutyltin dilaurate, dibutyltin ox-ide (e.g., as a liquid solution in C8-C10 phthalate), dibutyltin dilaurylmercaptide, dibutyltin bis (2-ethylhexylthioglycolate), dimethyltin dilaurylmercaptide, diomethyltin dineodecanoate, dimethyltin dioleate, dimethyltin bis (2-ethylhexylthioglycoate), dioctyltin dilaurate, dibutyltin bis (2-ethylhexoate), stannous octoate, stannous oleate, dibutyltin dimaleate, dioctyltin dimaleate, dibutyitin maleate, dibutyltin mercapto-propionate, dibutyltin bis (isoodyithioglycolate), dibutyltin diacetate, dioctyltin oxide mixture, dioctyltin oxide, dibutyltin diisooctoate, dibutyltin dineodecanoate, dibutyltin carboxylate, dioctyitin carboxylate, and combinations thereof.

The isocyanate catalyst can be utilized in various amounts. For example, in various embodiments, the isocyanate catalyst is utilized in an amount of from 0.0001 to 10, from 0.0001 to 5, from 5 to 10, weight percent based on a total weight percent of re-actants or the isocyanate or any other value or range of values therebetween. Typically, an amount of catalyst used depends on a temperature of the process. For example, at 150° F. (about 65.5° C.), 0.0001% may be utilized, while at room temperature 0.001 to 10%, such as 5-10%, such as 0.001 to 1%, may be utilized.

The isocyanate-reactive component can also include a “curing agent”, i.e., a cross-linker that crosslinks the carbon-carbon double bonds of a polydiene polyol, if present. Examples of curing agents include, but are not limited to, organic peroxides, sulfur, and organic sulfur-containing compounds. Non-limiting examples of organic peroxides include dicumyl peroxide and t-butylperoxyisopropyl benzene. Non-limiting examples of organic sulfur-containing compounds include thiuram based vulcanization promoters such as tetramethylthiuram disulfide (TMTD), tetraethylthiuram disulfide (TETD), and dipentamethylenethiuram tetrasulfide (DPTT), 4,4′-dithiomorpholine.

The isocyanate-reactive component used in forming the new polyurethane article, or new polyurethane foam article, can also include an adhesion promoter. The adhesion promoter may be a silicon-containing adhesion promoter. Adhesion promoters are also commonly referred to in the art as coupling agents or binder agents.

The isocyanate-reactive component used in forming the new polyurethane article, or new polyurethane foam article, can also include a wetting agent. The wetting agent may be a surfactant. The wetting agent may include any suitable wetting agent or mixtures of wetting agents known in the art.

The isocyanate-reactive component used in forming the new polyurethane article, or new polyurethane foam article, may also include various additional additives. Suitable additives include, but are not limited to, anti-foaming agents, processing additives, plasticizers, chain terminators, surface-active agents, flame retardants, antioxidants, water scavengers, fumed silicas, dyes or pigments, ultraviolet light stabilizers, fillers, thixotropic agents, silicones, transition metals, and combinations thereof. The additive may be included in any amount as desired by those of skill in the art. Referring back to method for forming the new polyurethane article, in any of the aspects described above, the viscosity of one or more of the individual components used to form the second mixture, including the afore-mentioned isocyanate-functional polymer component, the second isocyanate component, and/or the isocyanate-reactive component, has a viscosity of from 5 to 10,000 centipoise, as measured in accordance with ASTM standard D2196. In this way, each of the components of the second mixture are sufficiently liquid to allow the components to mix and react to form the new polyurethane article or new polyurethane foam article.

The new polyurethane foam articles of the subject disclosure are formed by mixing and reacting the isocyanate-functional polymer component, the second isocyanate component and the isocyanate-reactive component in combination with any of the other optional components described above in the presence of a blowing agent. The blowing agent of the subject disclosure may be a physical blowing agent, a chemical blowing agent, or a combination of a physical blowing agent and chemical blowing agent.

The physical blowing agent, such as those described above with respect to the polyurethane foams that may be used as the recycled polyurethane article, is typically introduced to the second mixture in an amount of from about 0.125 to about 15 parts by weight, such as from 4 to 6 parts by weight, based on 100 parts by weight of the combined weight of the active hydrogen content present in the isocyanate-reactive component and the blowing agent.

The chemical blowing agent, such as those described above with respect to the polyurethane foams that may be used as the recycled polyurethane article, is typically introduced in an amount such that, after reaction, the resultant blowing agent includes from about 0.125 to about 15 parts by weight, such as from 4 to 6 parts by weight, based on 100 parts by weight of the combined weight of the active hydrogen content present in the isocyanate-reactive component and the blowing agent.

The subject disclosure thus provides simple, efficient method for utilizing recycled polyurethane articles into new and useful materials, including new isocyanate-functional polymer components and polyurethane articles or polyurethane foam articles.

In another embodiment, the invention provides a method of recycling a pre-formed polyurethane article including: (a) processing and/or densifying the pre-formed polyurethane article, (b) heating a toluene diisocyanate composition at a temperature ranging from about 130 to 165° C., (c) contacting the pre-formed polyurethane article with the heated toluene diisocyanate composition of (b), and (d) producing a soluble isocyanate terminated liquid pre-polymer, thereby recycling the pre-formed polyurethane article.

The term “recycling” as used herein, refers to the transformation of a pre-formed material into base material or element that can in turn be used for the generation of a “recycled” material. In the methods described herein, “recycling” polyurethane articles refers in general to the transformation of previously formed (“pre-formed”) polyurethane articles or materials (e.g., pre-formed polyurethane foam) into isocyanate terminated liquid pre-polymer, that can be used for the production of recycled polyurethane articles of material such as recycled polyurethane foam.

Any previously formed polyurethane article or material may be used, including those that were used for a prior intended purpose (such as, for example, footwear, automotive headliners or front panels, and the like) or were otherwise not used for any intended purpose (i.e., virgin material, such as scrap or unused commercial products and the like) as pre-formed material. For example, the previously formed polyurethane article or material includes a previously formed foam such as a foam with complex formulation (e.g., conventional foam, hyper-soft foam, viscoelastic foam and Krusader foam). The isocyanate terminated liquid pre-polymer is a base material that can be used in the production of any polyurethane article or material, regardless of the type of polyurethane article or material that it was derived from.

In one aspect, the pre-formed polyurethane article is a pre-formed polyurethane foam.

In various aspects, the pre-heating temperature ranges from about 160 to 165° C.

In another aspect, the pre-heating temperature is maintained throughout the contacting step. In many aspects, the contacting temperature ranges from about 130° C. to 165°° C. For example, the contacting temperature is maintained at about 130-135° C., 135-140° C., 140-145° C., 145-150° C., 150-155° C., 155-160°° C., 160-165° C., 130-140°° C., 140-150° C., 150- 160° C., 135-145° C., 145-155° C., 155-165° C., 130-145° C., 145-160° C., 135-150° C., 150-165° C., 130-150° C., 135-155° C., 140-160° C., 145-165° C., 130-155° C., 135-160° C., 140-165° C., 130-160° C., or 135-165° C.

In other examples, the contacting temperature is about 125, 130, 135, 140, 145, 150, 155, 160, 165 or 170° C. In various aspects, the contacting temperature ranges from about 160 to 165° C. For example, the contacting temperature includes 159° C., 160° C., 161° C., 162° C., 163° C., 164° C., 165° C. and 166° C.

In one aspect, the method further includes adding a catalyst after contacting pre-formed polyurethane article with the heated toluene diisocyanate composition to reduce recycling time.

As described above, pre-heating the toluene diisocyanate composition is a mean to optimize (e.g., render faster and/or more efficient) the transformation of the pre-formed polyurethane article into a polyurethane pre-polymer. The further optimization of the reaction includes the addition of a catalyst into the toluene diisocyanate composition.

The isocyanate-reactive component for use in forming the isocyanate-terminated prepolymers may also include one or more catalysts. The catalyst is typically present in the isocyanate-reactive component to catalyze the reaction between the isocyanate component and the isocyanate-reactive component. That is, isocyanate-reactive component typically includes a “polyurethane catalyst” which catalyzes the reaction between an isocyanate and a hydroxy functional group. It is to be appreciated that the catalyst is typically not consumed in the exothermic reaction between the isocyanate and the polyol. More specifically, the catalyst typically participates in, but is not consumed in, the exothermic reaction. The catalyst may include any suitable catalyst or mixtures of catalysts known in the art. Examples of suitable catalysts include, but are not limited to, gelation catalysts, e.g., amine catalysts in dipropylene glycol; blowing catalysts, e.g., bis (dimethylaminoethyl) ether in dipropylene glycol; and metal catalysts, e.g., organo-tin compounds, organo-bismuth compounds, organo-lead compounds, etc. In some aspects, the isocyanate catalyst is an amine catalyst. In other aspects, the isocyanate catalyst is an organometallic catalyst.

The isocyanate catalyst may be or include a tin catalyst. Suitable tin catalysts include, but are not limited to, tin (II) salts of organic carboxylic acids, e.g., tin (II) acetate, tin (II) octoate, tin (II) ethylhexanoate and tin (II) laurate. In one embodiment, the isocyanate catalyst is or includes dibutyltin dilaurate, which is a dialkyltin (IV) salt of an organic carboxylic acid. Specific examples of non-limiting isocyanate catalysts are commercially available from Air Products and Chemicals, Inc. of Allentown, PA, under the trademark DABCOR. The isocyanate catalyst can also include other dial kylti n (IV) salts of organic carboxylic acids, such as dibutyltin diacetate, dibutyltin maleate and dioctyltin diacetate.

Examples of other suitable but non-limiting isocyanate catalysts include iron (II) chloride; zinc chloride; lead octoate; tris (dialkylaminoalkyl)-s-hexahydrotriazines including tris (N,N-dimethylaminopropyl)-s-hexahydrotriazine; tetraalkylammonium hydroxides including tetramethylammonium hydroxide; alkali metal hydroxides including sodium hydroxide and potassium hydroxide; alkali metal alkoxides including sodium methoxide and potassium isopropoxide; and alkali metal salts of long-chain fatty acids having from 10 to 20 carbon atoms and/or lateral OH groups.

Further examples of other suitable but non-limiting isocyanate catalysts include N,N,N-dimethylaminopropylhexahydrotriazine, potassium, potassium acetate, N,N,Ntrimethyl isopropyl amine/formate, and combinations thereof. A specific example of a suitable trimerization catalyst is commercially available from Air Products and Chemicals, Inc. under the trademark POLYCAT®.

Yet further examples of other suitable but non-limiting isocyanate catalysts include dimethylaminoethanol, dimethylaminoethoxyethanol, triethylamine, N,N,N′,N′tetramethylethylenediamine, N,N-dimethylaminopropylamine, N,N,N′,N′,N″pentamethyldipropylenetriamine, tris (dimethylaminopropyl) amine, N,Ndimethylpiperazine, tetramethylimino-bis (propylamine), dimethylbenzylamine, trimethylamine, triethanolamine, N,N-diethyl ethanolamine, N-methylpyrrolidone, Nmethylmorpholine, N-ethylmorpholine, bis (2-dimethylamino-ethyl) ether, N,Ndimethylcyclohexylamine (DMCHA), N,N,N′,N′,N″-pentamethyldiethylenetriamine, 1,2-dimethylimidazole, 3-(dimethylamino) propylimidazole, and combinations thereof. In various embodiments, the isocyanate catalyst is commercially available from Air Products and Chemicals, Inc. under the trademark POLYCAT®. The isocyanate catalyst may include any combination of one or more of the aforementioned catalysts. In still other embodiments, the catalyst is chosen from DABCO TMR, DABCO TMR-2, DABCO HE, DABCO 8154, PC CAT DBU TA 1, PC CAT QI, Polycat® SA-1, Polycat® SA-102, salted forms, and/or combinations thereof.

In other embodiments, the catalyst is chosen from dibutyltin dilaurate, dibutyltin oxide (e.g., as a liquid solution in C8-C10 phthalate), dibutyltin dilaurylmercaptide, dibutyltin bis (2-ethylhexylthioglycolate), dimethyltin dilaurylmercaptide, diomethyltin dineodecanoate, dimethyltin dioleate, dimethyltin bis (2-ethylhexylthioglycoate), dioctyltin dilaurate, dibutyltin bis (2-ethylhexoate), stannous octoate, stannous oleate, dibutyltin dimaleate, dioctyltin dimaleate, dibutyltin maleate, dibutyltin mercaptopropionate, dibutyltin bis (isoodyithioglycolate), dibutyltin diacetate, dioctyltin oxide mixture, dioctyltin oxide, dibutyltin diisooctoate, dibutyltin dineodecanoate, dibutyltin carboxylate, dioctyltin carboxylate, and combinations thereof.

The isocyanate catalyst for use in forming the isocyanate-terminated prepolymers can be utilized in various amounts. For example, in various embodiments, the isocyanate catalyst is utilized in an amount of from 0.0001 to 10, from 0.0001 to 5, from 5 to 10, weight percent based on a total weight percent of reactants or the isocyanate or any other value or range of values therebetween. Typically, an amount of catalyst used depends on a temperature of the process. For example, at 150° F. (about 65.5° C.), 0.0001% may be utilized, while at room temperature 0.001 to 10%, such as 5-10%, such as 0.001 to 1%, may be utilized.

In some aspects, the catalyst includes dibutyltin dilaurate (DABCO T12).

In other aspects, the method further includes adding of diethylene glycol bis chloroformate (DIBIS).

The use of a catalyst in the reaction is associated with faster processing time but can also be associated with a loss of the stability of the product (e.g., the liquid polyurethane pre-polymer). I some aspects, the loss of stability of the liquid polyurethane pre-polymer includes a solidification of the polyurethane pre-polymer. Any chemical compound that mitigates the DABCO T12-induced overtime solidification of the pre-polymer can be used to maintain the stability and solubility of the pre-polymer. In various aspects, an equal mass loading of DIBIS is added to the composition and article fragments mixture.

In various aspects, DIBIS mitigates DABCO T12-induced overtime solidification of the pre-polymer.

In some aspects, DIBIS prevents DABCO T12-induced reduction of the pre-polymer stability.

The methods described herein rely on the contacting of the pre-formed polyurethane article with the heated toluene diisocyanate composition. In various aspects, the pre-formed polyurethane article is a pre-formed polyurethane foam having a low density and large volume. The present invention relies on the optimization of a recycling process of pre-formed polyurethane foam including increasing the contact surface of polyurethane foam that enters in contact with the heated toluene diisocyanate composition described herein. As previously describes, increasing such contact surface includes processing and/or densifying the pre-formed polyurethane article to obtain fragments of the article (e.g., by grinding, compression, compaction, . . . ) and stirring the mixture of the polyurethane composition/fragments to ensure the optimal contact of the fragments with the composition.

In some aspects, the toluene diisocyanate composition is selected from the group consisting of: a polyurethane composition comprising between about 50% and 75% of toluene-2,4-diisocyanate and between about 10% and 15% of toluene-2,6-diisocyanate; a polyurethane composition comprising between about 50% and 75% of toluene-2,4-diisocyanate and between about 15% and 20% of toluene-2,6-diisocyanate; and a polyurethane composition comprising between about 60% and 80% of toluene-2,4-diisocyanate and between about 10% and 20% of toluene-2,6-diisocyanate.

In an additional embodiment, the invention provides a method of converting a pre-formed polyurethane article into a liquid polyurethane material including: (a) processing and/or densifying the pre-formed polyurethane article, (b) heating a toluene diisocyanate composition at a temperature ranging from about 130 to 165° C., (c) contacting the pre-formed polyurethane article with the heated toluene diisocyanate composition of (b), and (d) producing a soluble isocyanate terminated liquid pre-polymer, thereby converting the pre-formed polyurethane article into a liquid polyurethane material.

In various aspects, the pre-heating temperature ranges from about 160 to 165° C.

In another aspect, the pre-heating temperature is maintained throughout the contacting step. In many aspects, the contacting temperature ranges from about 130° C. to 165° C. For example, the contacting temperature is maintained at about 130-135° C., 135-140° C., 140-145° C., 145-150° C., 150-155° C., 155-160° C., 160-165° C., 130-140° C., 140-150° C., 150-160° C., 135-145° C., 145-155° C., 155-165° C., 130-145° C., 145-160° C., 135-150° C., 150-165° C., 130-150°° C., 135-155° C., 140-160° C., 145-165° C., 130-155° C., 135-160°° C., 140-165° C., 130-160° C., or 135-165° C.

In other examples, the contacting temperature is about 125, 130, 135, 140, 145, 150, 155, 160, 165 or 170° C. In various aspects, the contacting temperature ranges from about 160 to 165° C. For example, the contacting temperature includes 159° C., 160° C., 161° C., 162° C., 163° C., 164° C., 165° C. and 166° C.

In one aspect, converting the pre-formed polyurethane article includes producing a polyurethane pre-polymer.

As described herein, the term “liquid form” generally coincides with the substantial absence of a “solid form” as determined by visual inspection. It is recognized herein, for the purposes of the subject disclosure, that the liquid polyurethane pre-polymer is considered to be in “liquid form” even when a small percentage, such as less than 5% by weight, and more typically less than 1% by weight, of the total weight of the polyurethane pre-polymer remains in solid form. This residual material may be in the form of insoluble particles or other materials that remain. These insoluble particles or materials may include various additives, such as inorganic fillers and the like, or other organic materials, or in certain instance may be a small portion of residual recycled polyurethane article that is not transformed as remains visible as described above.

Once the visual inspection confirms the substantial absence of the solid form, the extent of the reaction can be confirmed by measuring the isocyanate-functional group content (i.e., the NCO content, sometimes referred to as the free NCO content) of the formed isocyanate-functional polymer component, which is based on the total weight of the isocyanate-functional polymer component. The total weight of the isocyanate-functional polymer component is the sum total of the weight of the recycled polyurethane article in liquid form and the weight of the isocyanate component (i.e., the weight of the mixture, prior to reaction). The NCO content can be determined by conventional methods known to those of ordinary skill in the analysis of polyurethanes in accordance with ASTM D2572, as noted above. A reaction is confirmed when the measured NCO content of the isocyanate-functional polymer component is less than the NCO content of the isocyanate component.

In some aspects, the pre-polymer is used for the production of industrial chemicals and/or industrial polymers.

Presented below are examples discussing the conversion of pre-formed polyurethane article into polyurethane prepolymers, contemplated for the discussed applications. The following examples are provided to further illustrate the embodiments of the present invention but are not intended to limit the scope of the invention. While they are typical of those that might be used, other procedures, methodologies, or techniques known to those skilled in the art may alternatively be used.

### EXAMPLE

### Example 1

### Conversion of Polyurethane foams into Polyurethane Pre-Polymer in a Continuous Process

Various foam, including foam with complex formulation (conventional foams, hypersoft foams, viscoelastic foams and Krusader foams) can be digested in batch. The improved method described herein has been implemented using conventional foam.

It was found that the processing of the foam and its densification prior to digestion allowed for a consistent feed rate in lab-scale. Running the process at the desired temperature of 165° C. by preheating of the TDI in an external vessel allowed dosing of the foam and TDI concurrently in an extruder to create a reaction environment suitable for digestion of the foam.

It was found that a residence time of 5 minutes was desirable in an extruder to facilitate adequate processing. If shorter times were required, it was also found that addition of a polyurethane catalyst, specifically active tin catalyst DABCO T-12 (dibutyltin dilaurate), was needed in certain amounts to reduce the processing time to shorter times of less than a minute. However, addition of the catalyst was found to diminish stability of the resulting liquid sample and material would solidify over time. This behavior was shown to be mitigated in the lab with test prepolymer systems through the addition of equal mass loadings of diethylene glycol bis chloroformate (also known in the industry as DIBIS).

The reduced volume of TDI and foam in the reactor of the continuous process reduces the risk and allowed for more control over the process compared to the batch process while not limiting the throughput and delivering similar product quality.

Addition of a polyurethane catalyst in conjunction with acidifying agent post-process allows for a reduction in residence time while allowing for improved stability compared to a uncatalyzed system or catalyzed system without acidification.

Addition of the foam in a continuous manner in conjunction with the extruder allowed for complete addition of the foam to the process since the extruder is able to compress the foam into the required volume of the extruder. For foam that would be cut into one-inch cubes, the volume difference is roughly 20 times greater than the liquid and would require in batch mode either a very large reactor headspace or stepwise addition of the foam over a period of time.

Although the invention has been described with reference to the above examples, it will be understood that modifications and variations are encompassed within the spirit and scope of the invention. Accordingly, the invention is limited only by the following claims.

1-32. (canceled)

33. A method of producing a polyurethane pre-polymer comprising:
a) processing and/or densifying a pre-formed polyurethane article,
b) pre-heating a toluene diisocyanate composition at a temperature ranging from about 130 to 165° C., and
c) contacting the processed and/or densified pre-formed polyurethane article with the toluene diisocyanate composition,
thereby producing a polyurethane pre-polymer.

34. The method of claim 33, wherein the toluene diisocyanate composition comprises between about 50% and 75% of toluene-2,4-diisocyanate and between about 10% and 15% of toluene-2,6-diisocyanate.

35. The method of claim 33, wherein the toluene diisocyanate composition comprises between about 50% and 75% of toluene-2,4-diisocyanate and between about 15% and 20% of toluene-2,6-diisocyanate.

36. The method of claim 33, wherein the toluene diisocyanate composition comprises between about 60% and 80% of toluene-2,4-diisocyanate and between about 10% and 20% of toluene-2,6-diisocyanate.

37. The method of claim 33, wherein the pre-formed polyurethane article is a polyurethane foam.

38. The method of claim 33, wherein the processing and/or densifying step occurs prior to, after, or concurrently with the pre-heating step.

39. The method of claim 33, wherein increasing the pre-heating temperature decreases processing time.

40. The method of claim 37, wherein the polyurethane foam is selected from the group consisting of microcellular foam, semi-rigid foam, molded foam, and any combination thereof.

41. The method of claim 40, wherein the foam comprises polyols having a molecular weight ranging from about 1000 to 3600 Da.

42. The method of claim 37, wherein processing and/or densifying the foam comprises grinding the foam to obtain shredded foam.

43. The method of claim 42, wherein the shredded foam fragments have a size ranging from about 500 μm to 5 mm.

44. The method of claim 42, wherein the shredded foam fragments have a size of about 1 mm.

45. The method of claim 37, wherein processing and/or densifying comprises using a grinder, a processor, a shredder, a granulator, a crusher, a compactor or a miller.

46. The method of claim 33, wherein the production is a continuous process.

47. The method of claim 33, wherein the pre-heating temperature ranges from about 160 to 165° C.

48. The method of claim 33, wherein contacting comprises contacting about 1-30% w/w foam with the polyurethane composition.

49. The method of claim 33, further comprising stirring the pre-formed polyurethane article and the heated polyurethane composition.

50. The method of claim 33, wherein the temperature of the toluene diisocyanate composition is maintained at a temperature ranging from about 130 to 165° C. during the contacting step c).

51. The method of claim 33, further comprising adding a catalyst after step (b).

52. A method of recycling a pre-formed polyurethane article comprising:
(a) processing and/or densifying the pre-formed polyurethane article,
(b) pre-heating a toluene diisocyanate composition at a temperature ranging from about 130 to 165° C.,
(c) contacting the pre-formed polyurethane article with the pre-heated toluene diisocyanate composition of (b), and
(d) producing a soluble isocyanate terminated liquid pre-polymer, thereby recycling the pre-formed polyurethane article.

53. The method of claim 52, wherein the pre-heating temperature ranges from about 160 to 165° C.

54. The method of claim 52, wherein the pre-formed polyurethane article is a pre-formed polyurethane foam.

55. The method of claim 52, further comprising adding a catalyst after step (b).

56. The method of claim 55, wherein the catalyst comprises dibutyltin dilaurate (DABCO T12).

57. The method of claim 55, further comprising adding diethylene glycol bis chloroformate (DIBIS).

58. The method of claim 57, wherein DIBIS mitigates DABCO T12-induced overtime solidification of the pre-polymer.

59. The method of claim 57, wherein DIBIS prevents DABCO T12-induced reduction of the pre-polymer stability.

60. The method of claim 52, wherein the toluene diisocyanate composition is selected from the group consisting of:
(i) a polyurethane composition comprising between about 50% and 75% of toluene-2,4-diisocyanate and between about 10% and 15% of toluene-2,6-diisocyanate;
(ii) a polyurethane composition comprising between about 50% and 75% of toluene-2,4-diisocyanate and between about 15% and 20% of toluene-2,6-diisocyanate; and
(iii) a polyurethane composition comprising between about 60% and 80% of toluene-2,4-diisocyanate and between about 10% and 20% of toluene-2,6-diisocyanate.

61. A method of converting a pre-formed polyurethane article into a liquid polyurethane material comprising:
(a) processing and/or densifying the pre-formed polyurethane article,
(b) pre-heating a toluene diisocyanate composition at a temperature ranging from about 130 to 165° C.,
(c) contacting the processed and/or densified pre-formed polyurethane article with the heated toluene diisocyanate composition of (b), and
(d) producing a soluble isocyanate terminated liquid pre-polymer, thereby converting the pre-form polyurethane article into a liquid polyurethane material.

62. The method of claim 61, wherein the pre-heating temperature ranges from about 160 to 165° C.

63. The method of claim 61, wherein converting the pre-formed polyurethane article comprises producing a liquid polyurethane pre-polymer.

64. The method of claim 63, wherein the pre-polymer is used for the production of industrial chemicals and/or industrial polymers.
